(19) United States
(12) Patent Application Publication
(10) Pub. No.: US 2025/0033118 A1
(43) Pub. Date: Jan. 30, 2025

(54) MULTI-LASER POWDER BED ADDITIVE MANUFACTURING SYSTEMS WITH LOAD BALANCING

(71) Applicant: UT-BATTELLE, LLC, Oak Ridge, TN (US)

(72) Inventors: Benjamin C. Stump, Knoxville, TN (US); Brian T. Gibson, Knoxville, TN (US); Jay T. Reynolds, Knoxville, TN (US); Peter L. Wang, Oak Ridge, TN (US)

(73) Assignee: UT-BATTELLE, LLC, Oak Ridge, TN (US)

(21) Appl. No.: 18/780,845

(22) Filed: Jul. 23, 2024

Related U.S. Application Data
(60) Provisional application No. 63/529,473, filed on Jul. 28, 2023.

(51) Int. Cl. B22F 10/28; B22F 10/366; B22F 10/85; B22F 12/45; B33Y 30/00; B33Y 50/02

(52) U.S. Cl. CPC B22F 10/28; B22F 10/366; B22F 10/85; B22F 12/45; B33Y 30/00; B33Y 50/02

(57) ABSTRACT

A powder-bed fusion system, comprising: a laser-based heat source configured to direct laser beams to a powder bed within respective fields of views (FOVs); and a controller configured to: obtain information specifying predetermined paths over which the laser-based heat source is to direct the laser beams to form objects by fusing layers of powder disposed on the powder bed; create a first mapping between portions of the objects within overlapping FOVs and the laser beams associated with the overlapping FOVs; use the first mapping to determine a first distribution of the laser beams for forming the objects while balancing usage of the laser beams; and cause the laser-based heat source to direct the laser beams to locations on the powder bed in accordance with the first distribution.

### CROSS-REFERENCE TO RELATED APPLICATION(S)

The present application claims priority to and the benefit of U.S. Provisional Patent Application Ser. No. 63/529,473 which was filed on Jul. 28, 2023. The content of this Provisional Patent Application is incorporated by reference in its entirety.

### STATEMENT REGARDING FEDERALLY SPONSORED RESEARCH AND DEVELOPMENT

The technologies described herein were developed with government support under Contract No. DE-AC05-00OR22725 awarded by the U.S. Department of Energy. The government has certain rights in the described technologies.

### BACKGROUND

### Description of the Related Art

As powder bed fusion (PBF) additive manufacturing (AM) becomes a more mature field, system configurations are gradually moving away from the classic single heat source, layer-by-layer system configurations towards unconventional system configurations that offer higher throughput. Additive manufacturing (AM) is experiencing a transformation in production capabilities, challenging the belief that small build volumes and slow production rates limit its applicability to mass production. Metal additive manufacturing processes, such as directed energy deposition (DED) and PBF, have gained significant traction across industries like automotive, aerospace, medical, construction, oil and gas, and rail. As a result of its diverse industrial applications, there is a growing interest in tailoring AM systems to optimize the production of specific parts, a concept long embraced by the machine tool industry.

### SUMMARY

The present disclosure concerns a powder-bed fusion system. The powder-bed fusion system comprises a laser-based heat source and a controller. The laser-based heat source is configured to direct laser beams to a powder bed within respective fields of views (FOVs) such that one or more locations on the powder bed is within (i) at least two FOVs when a build plate is stationary relative to the FOVs or (ii) any of the FOVs when the build plate is moved relative to the FOVs. The controller is configured to: obtain information specifying predetermined paths over which the laser-based heat source is to direct the laser beams to form objects by fusing layers of powder disposed on the powder bed; create a first mapping between portions of the objects within overlapping FOVs and the laser beams associated with the overlapping FOVs; use the first mapping to determine a first distribution of the laser beams for forming the objects while balancing usage of the laser beams; and cause the laser-based heat source to direct the laser beams to locations on the powder bed in accordance with the first distribution.

The present disclosure also concerns a non-transitory computer-readable medium that stores instructions that is configured to, when executed by at least one computing device, cause at least one computing device to perform operations comprising: obtaining information specifying predetermined paths over which a laser-based heat source is to direct laser beams to form objects by fusing layers of powder disposed on a powder bed; creating a first mapping between portions of the objects within overlapping FOVs and the laser beams associated with the overlapping FOVs; using the first mapping to determine a first distribution of the laser beams for forming the objects while balancing usage of the laser beams; and controlling the laser-based heat source to emit the laser beams and direct the laser beams to locations on the powder bed in accordance with the first distribution.

### BRIEF DESCRIPTION OF THE DRAWINGS

The present solution will be described with reference to the following drawing figures, in which like numerals represent like items throughout the figures.

FIG. 1 provides illustrations of system configurations for multi-laser PBF (ML-PBF) systems.

FIGS. 2A-2E (collectively referred to herein as “FIG. 2”) provide illustrations of different types of heat source configurations. Each box represents the field of view of a heat source. Configurations of FIGS. 2A-2D are for layer-by-layer AM systems whereas the configuration of FIG. 2E is for a continually printing system.

FIG. 3 provides an illustration showing the physical counterpart to what is described in a Spatially Complex example. The legend shows the colored boxes associated with each laser as well as how object which are assigned or unassigned are represented. Here, the “next object” refers to the next object considered for balancing in the greedy approach ({O₁}). Additionally, the top left corner of each colored box also contains the associated laser number.

FIG. 4 provides an illustration showing the physical counterpart to what is described in a Spatially Completely Overlapping without Temporal Overlap example. The legend shows the colored boxes associated with each laser as well how to determine if an object has been scanned or not. Additionally, the top left corner of each colored box also contains the associated laser number. The time it takes to scan a position is equal to the maximum time a heat source assigned to scan in that position. In this example, the times to scan positions (Pₙ, Pₙ₊₁, Pₙ₊₂) are {5, 0, 2} when using the greedy approach.

FIGS. 5A-5B (collectively referred to herein as “FIG. 5”) provide illustrations of configurations with two different temporal connectivities. Here, S denotes the sectors, while the colored squares represent the active regions. These active regions contain the heat sources labeled by H.

FIG. 6 provides illustrations showing the significance of the order in which scan segments are printed. In this figure, the solid lines represent scan segments, while the dashed lines represent the jumps between consecutive scan segments. The total scan time is influenced by the lengths of both the dotted and solid lines. The scan order depicted on the left would result in a quicker scan time compared to the scan order shown on the right.

FIG. 7 provides illustrations showing a general overview of object splitting involving two objects and two heat sources. In FIG. 7, object 2 is split, giving rise to a new object 2 and object 3. Achieving optimal load balancing is accomplished by assigning objects 1 and 3 to one heat source, while assigning object 2 to the other heat source.

FIG. 8 provides an illustration showing the average, as denoted by the black dot, and standard deviation of the approximation ratios for the configurations listed in TABLE 3.

FIG. 9 provides graphs showcasing how the performance of partial-balancing both exceeds the Naive approach and approaches the full-balancing approach as the look ahead number increases.

FIG. 10 provides graphs showing the convergence of the iterative method for Spatially Complex configurations. {G1, G2, G3, G4} represent the same setups as is FIG. 10. The learning rate is 0.05.

FIG. 11 provides graphs showing convergence and speed of the iterative method for two Spatially Completely Overlapping without Temporal Overlap configurations, T1 and T2, for various values for the look ahead number, n, and number of partial iterations, s. The learning rate is 0.05.

FIG. 12 provides 3D solid models that were sliced to run in the rotary powder bed system. The left image shows the “Text ring” model, while the right image shows the “Lattice ring” model.

FIG. 13 provides an illustration of the heat source assignments for the first layer of objects in three scenarios: (A) the default case, (B) after applying the discrete approach for full balancing, and (C) after applying the continuous approach for full balancing. The black boxes outline the fields of view for the different heat sources. The sectors are represented by alternating bands of lighter or darker colors. The green objects are assigned to be scanned by the top heat source, while the blue objects are assigned to be scanned by the bottom heat source. The inset in (A) shows the reconstruction as a composition of actual scan vectors.

FIG. 14 provides an illustration depicting the heat source assignments for the first layer of objects in two scenarios: (A) the default case and (B) after applying the continuous approach for full balancing. The black boxes outline the fields of view for the different heat sources. The sectors are represented by alternating bands of lighter or darker colors. The green objects are assigned to be scanned by the top heat source, while the blue objects are assigned to be scanned by the bottom heat source.

FIG. 15 provides illustrations showing a build created to run on the rotary powder bed system. The maximum outer diameter of this build is 580 mm. The load balancing described herein reduced the build time by 11%.

FIG. 16 provides an illustration of a system implementing the present solution.

FIG. 17 provides an illustration that is useful in understanding how object(s) are manufactured.

FIGS. 18A-18B (collectively referred to herein as “FIG. 18”) provide a flow diagram of an illustrative method for operating a system to perform an additive manufacturing process to form object(s).

FIGS. 19-20 each provides an illustration that useful for understanding how mappings are created.

FIG. 21 provides a flow diagram of an illustrative method for determining a distribution of laser beams for forming object(s).

FIGS. 22-23 each provides a flow diagram of another illustrative method for determining a distribution of laser beams for forming object(s).

FIG. 24 provides a block diagram of an illustrative computing device.

### DETAILED DESCRIPTION

As PBF AM becomes a more mature field, system configurations are gradually moving away from the classic single heat source, layer-by-layer system configurations towards unconventional system configurations that offer higher throughput. Higher throughput systems allow PBF systems to be considered for a larger variety of industrial applications. However, the inclusion of multiple heat sources, or beams, also increases the complexity of the control schemes needed. For multi-beam systems with overlapping fields of view, the distribution of workload, or load balancing, across these beams directly affects the total print time for a build. Additionally, the probability of any beam failing in a multi-beam system increases with the number of beams. While manual methods of load balancing and dealing with beam failures are reasonable for current generation multi-beam systems, as system configurations become more complex, manual methods will become prohibitively inefficient. Two different ways are described below to load balance multi-beam systems of various configuration types, regardless of their complexity, which are highly performant. A consequence of this performance is the enablement of on-the-fly load balancing in the event a beam fails, thus improving system robustness.

The present solution increases throughput for multi-laser additive systems by minimizing the amount of time lasers are idle for. The solution implements a technique for intelligently distributing the workload between the lasers. The present solution will be described in terms of algorithms for increasing throughput on a variety of configurations of multi-laser additive systems through intelligent assignment of work to the individual lasers. The present solution can increase throughput for multi-laser additive systems, and enable on-the-fly balancing if a laser were to stop functioning mid-build, thus leading to improved system robustness.

The present solution can be used in various applications. Such applications can include, but are not limited to, manufacturing applications, materials applications, and/or multi-laser AM system applications.

As noted above, AM is experiencing a transformation in production capabilities, challenging the belief that small build volumes and slow production rates limit its applicability to mass production. Metal additive manufacturing processes, such as directed energy deposition (DED) and PBF, have gained significant traction across industries like automotive, aerospace, medical, construction, oil and gas, and rail. As a result of its diverse industrial applications, there is a growing interest in tailoring AM systems to optimize the production of specific parts, a concept long embraced by the machine tool industry.

Among the various metal AM processes, DED and PBF are particularly popular for different reasons. DED processes, specifically wire DED (W-DED), offer high build rates, while PBF processes excel in part quality, fine feature control, and site-specific microstructure control. Consequently, both technologies have attracted interest, but PBF has received more extensive research due to having finer control of the thermal conditions experienced during the process, leading to the development of numerous simulation tools for modeling and controlling these processes.

Laser PBF (L-PBF) has recently garnered significant attention from equipment manufacturers and researchers due to its aforementioned benefits and potential scalability for increased throughput. Multi-laser hardware configurations, known as ML-PBF, offer high temporal and spatial resolution, with productivity scaling alongside the number of lasers available. These systems retain the fine process control of L-PBF while significantly improving throughput. Unique system considerations for ML-PBF include the number and arrangement of lasers and the Field-of-View (FOV) overlap, while unique process considerations include laser-to-laser stitching quality and shield gas flow interaction. Research in ML-PBF processing has encompassed investigations into laser-matter interactions at overlap regions, multi-laser stitching quality, spatter formation, defect formation, residual stress, and microstructure and mechanical property characterizations for various materials. Additionally, research on ML-PBF scanning strategies has focused on the impact on temperature distribution and thermal gradients within a layer. Multi-beam coordination strategies, including cross-section subdivision, sequencing, and load balancing, have implications for both the system and the process.

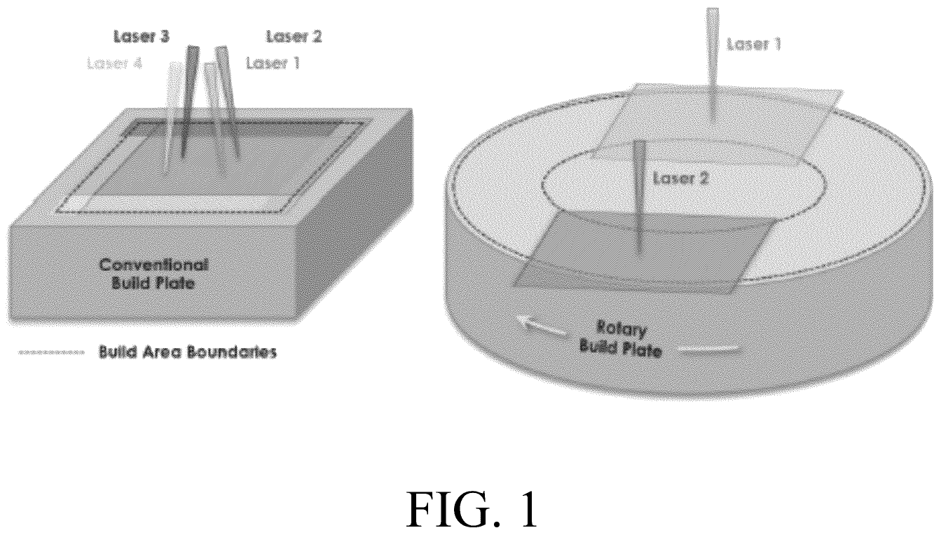

A significant research gap exists in load balancing strategies for multi-beam AM processes, as it directly affects system throughput and productivity. While some industry efforts have addressed load balancing for new ML-PBF systems entering the market, detailed algorithm-level information is often not publicly available. The complexity of load balancing depends on the specific configuration of the ML-PBF system. These configurations can be classified as classical Cartesian type with varying degrees of FOV overlap or novel rotary type, where FOV overlap is not required. Rotary ML-PBF systems enable continuous deposition and multiple material deposition zones, offering the potential for high productivity and precise local process control to tailor material properties for specific applications. FIG. 1 illustrates these two system configurations.

Conventional solutions lack comprehensive load balancing strategies for multi-beam AM processes. Load balancing methods are described herein for various ML-PBF system configurations, regardless of complexity. These disclosed methods effectively reduce the total print time for builds on a variety of system configurations. Moreover, their computational efficiency enables their potential use for on-the-fly load balancing in case of beam failures, thereby enhancing a system's robustness.

### Partition Problems

A branch of problems in computer science and mathematics dealing with splitting multisets of numbers into subsets is known as partition problems. A multiset is simply a set allowed to have repeats, such as the multiset containing the integers {2, 4, 3, 1, 3} where the integer 3 has a multiplicity of two. One such problem, dubbed multiway number partitioning, has the goal of partitioning a multiset of numbers into a fixed number of subsets such that the sum of these subsets is as similar as possible. This problem is known to be NP-hard, which essentially means the computational complexity of finding the exact solution scales extremely quickly as the number of subsets or size of the multiset increases. However, there are several heuristics that can be used to find approximate solutions quickly.

One such heuristic for this problem is known as greedy number partitioning where, while looping overall numbers in the multiset, each number is put in the subset with the current smallest sum. However, a large improvement can be made by first sorting the numbers in the multiset from largest to smallest as shown in TABLE 1.

TABLE 1

| Step | Multiset | Subset 1 | Subset 2 | Multiset | Subset 1 | Subset 2 |
|---|---|---|---|---|---|---|
| 0 | {5, 2, 4, 7, 4} | {} | {} | {7, 5, 4, 4, 2} | {} | {} |
| 1 | {2, 4, 7, 4} | {5} | {} | {5, 4, 4, 2} | {7} | {} |
| 2 | {4, 7, 4} | {5} | {2} | {4, 4, 2} | {7} | {5} |
| 3 | {7, 4} | {5} | {2, 4} | {4, 2} | {7} | {5, 4} |
| 4 | {4} | {5, 7} | {2, 4} | {2} | {7, 4} | {5, 4} |
| 5 | {} | {5, 7} | {2, 4, 4} | {} | {7, 4} | {5, 4, 2} |

Since this problem has many real-world applications, such as multiprocessor scheduling, there have been several attempts in the literature to find heuristics leading to closer approximations.

### Slicing

The slicing process is a crucial step in AM that prepares a 3D object for printing. It involves dividing the object into thin layers and generating the necessary scan vectors or paths for the printing system to follow. The process begins by evaluating the input file, typically in the form of a stereolithography (STL) file, which represents the 3D object as a collection of triangular faces. These faces are then intersected with horizontal planes, offset according to the desired layer height, to create cross-sectional slices. The intersections of the plane with the triangle faces generate line segments that are connected to form one or more polygons representing the solid regions that need to be printed.

Once the 2D solid areas have been defined, the slicing process proceeds to compute the pathing for printing. The first set of paths to be computed are the perimeters. Perimeters are closed loops that outline the boundaries of the polygons. These perimeters can be generated by offsetting the polygon boundaries from their centroid. This offsetting process, known as erosion or dilation, adjusts the size of the polygons.

After generating the perimeter paths, the infill paths for the interior of the solid areas are computed. One common infill pattern is the line hatch pattern, which includes parallel lines that fill the remaining space within the polygons. The hatch pattern is often rotated layer by layer to create a denser structure once the printing is completed.

Once the major pathing computation is done, an optimization step is performed to refine the pathing according to specific criteria. These criteria can vary depending on the printing system and process. For example, in a rotary ML-PBF system, the construction might be optimized to occur in the opposite direction of rotation and from the interior to exterior edges. Hatching patterns may also be organized to alternate the construction direction of neighboring hatches. Finally, the resulting optimized pathing is output in a suitable format such as the Common Layer Interface (CLI), which provides a standardized representation of the sliced data that can be understood by various printing systems.

### Timing Estimation

To treat the load balancing problem as a partition problem, the scan times are estimated for each object produced during the slicing process. The timing estimation depends on factors such as the scan vectors, their order, and the machine specifications, including the maximum speed of the heat source.

Since a scan vector within an object may have a different end location than the start location of the next scan vector, the timing estimation accounts for the travel time between these locations. This includes the time it takes for the system to move from one location to another. Additionally, if the adjoining scan vectors have different angles or directions, the heat source may need to accelerate or adjust its position physically. Therefore, a proper timing estimation for a given scan vector should include the preparation time required for the system to print it.

Assuming that the timing for individual scan vectors is accurately computed as described above, the timing for an object can be calculated as the sum of the timings of all scan vectors contained within it.

### Problem Definition

Load balancing on AM systems with multiple heat sources aims to minimize the printing time of a build by intelligently assigning the work to each heat source. One possible approach to achieving an optimal work distribution is by treating load balancing as a partition problem. In this context, the time or work required to scan each object Oᵢ is represented by a multiset of numbers tᵢ∈T, and the subsets hⱼ∈H represent the work assigned to each heat source.

However, unlike the standard partition problem discussed earlier, the assignment of work to heat sources is subject to constraints imposed by the system configuration. Each heat source has a finite field of view, which means that it may not be capable of scanning all objects. This constraint significantly affects the nature of the partition problem and its potential solutions. Therefore, the specific characteristics of the partition problem heavily depend on the system configuration.

Several different system configurations and their corresponding partition problems are now considered. For simplicity, an assumption is made that each system configuration has identical heat sources. This means that configurations with lasers having multiple parameters are not considered in this analysis. However, the present solution is not limited in this regard.

### No Spatial Overlapping

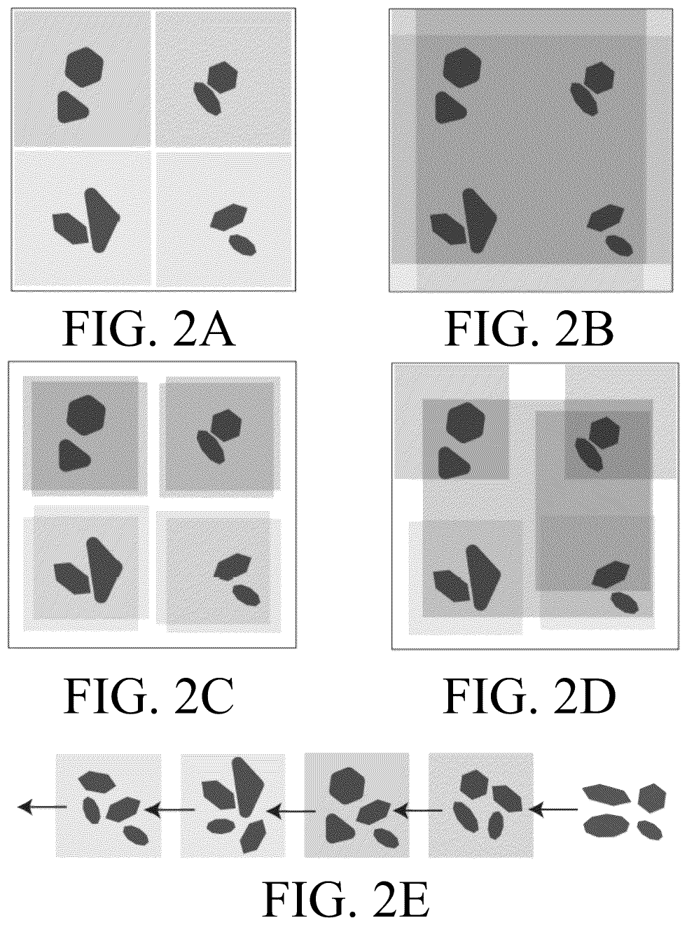

In the system configurations shown in FIG. 2A, the field of view for each heat source is completely separate from the fields of view for every other heat source. Consequently, each object can only be in the field of view for a single heat source. Configurations such as these cannot be load balanced as each object can only be scanned by a single heat source.

### Spatially Completely Overlapping

In the system configuration shown in FIG. 2B, each object is contained within every field of view. This means that any object can be assigned to be scanned by any heat source. Thus, load balancing of these system configurations can be directly approached as a multiway number partitioning problem.

### Multiple Spatially Distinct Completely Overlapping

In the system configurations shown in FIG. 2C, multiple fields of view overlap. However, the overlapping regions can be neatly sectioned out. Another way to put this is that each object in a set of fields of views shares the same set as any other object in any of these fields of view within the set. These system configurations can be load balanced since objects can be assigned to more than one heat source but, for simplification, each set of fields of view which can be sectioned out should be treated as a separate Spatially Completely Overlapping configuration.

### Spatially Complex

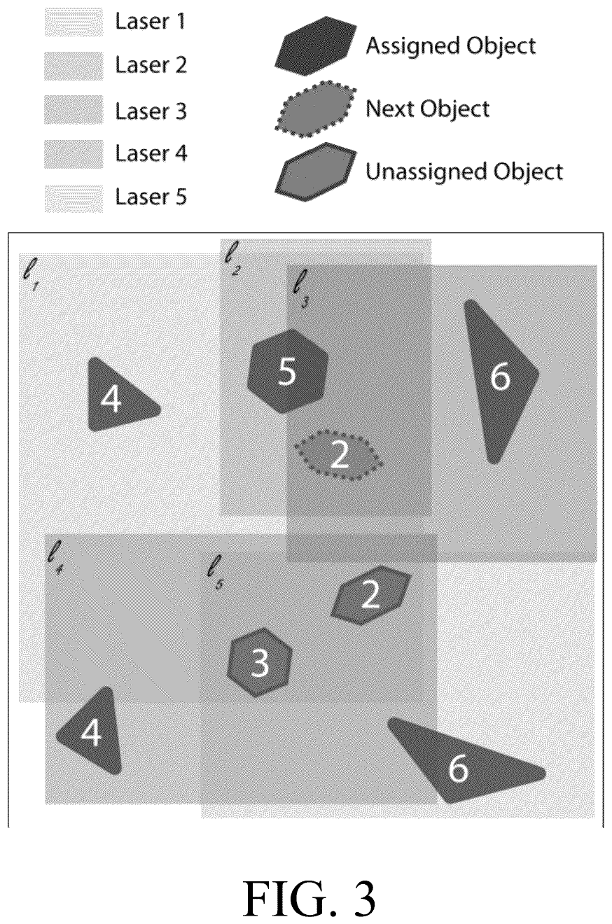

In the system configurations shown in FIG. 2D, objects can be contained within multiple fields of view overlap but without these overlapping sections being able to be neatly sectioned to reduce problem complexity, like in Multiple Spatially Distinct Completely Overlapping configurations. Load balancing on these configurations is difficult since there are no existing heuristics to tackle such problems. Thus, the current way to approach this problem is to check every permutation and choose whichever minimizes the total time. A naive heuristic based on the Greedy Number Partitioning algorithm could be implemented although the results, as seen in FIG. 3, can be highly suboptimal.

Example: Imagine object {O₁} lies in the field of view of lasers {l₁, l₂, l₃}. If the already distributed scan times to the lasers are {4, 5, 6} respectively and the scan time for {O₁} is {2}, the most straightforward strategy is to assign {O₁} to {lᵢ} since it has the least assigned scan time. However, if the remaining objects {O₂, O₃} with scan times {2, 3} can only be distributed to lasers {l₁, l₄, l₅} with already distributed scan times {4, 4, 6}, then this strategy is suboptimal as it would lead to be best case scenario of {l₁, l₂, l₃, l₄, l₅} having loads {6, 5, 6, 7, 8}. The ideal solution in this case is {l₁, l₂, l₃, l₄, l₅} having scan times {6, 7, 6, 7, 6}. Since completion is not attained until all loads are complete, the quality of the solution is based on the slowest member. Therefore, naively applying an algorithm akin to Greedy Number Partitioning results in a solution that is roughly 14% worse than the ideal solution.

Spatially Completely Overlapping without Temporal Overlap

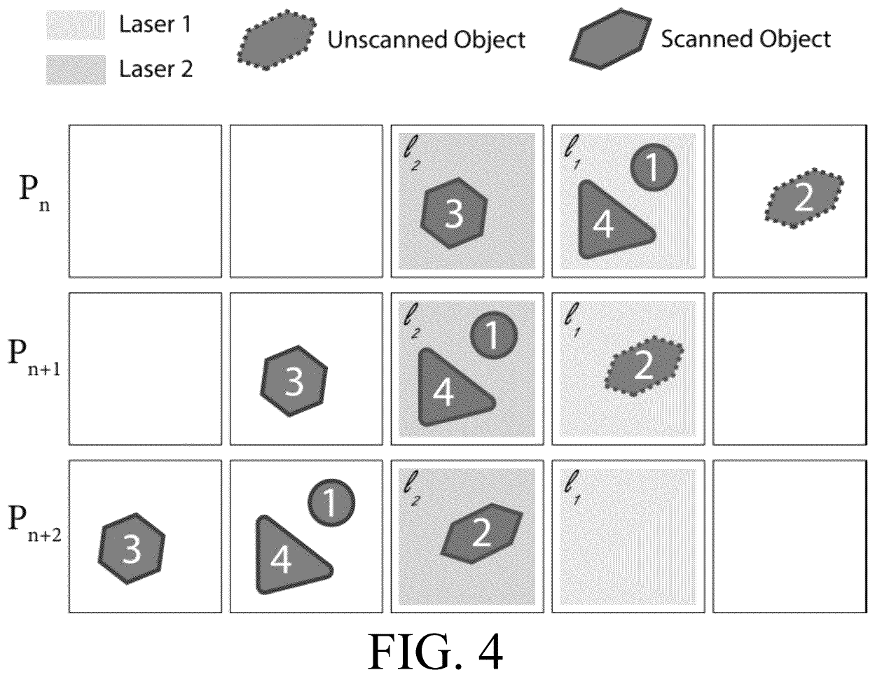

In these system configurations shown in FIG. 2E, each field of view, or sectioned set of fields of view will contain every object; however, the time at which they contain the object will be different. There are multiple ways to visualize such a configuration but the simplest may be to view it like a treadmill. Load balancing such a problem is also very difficult since, like for Spatially Complex configurations, there are no existing heuristics to find a good solutions without checking every possibility, as shown in FIG. 4.

Unlike all previous configurations which print layer-to-layer and thus have the constraint that each object much be scanned before the layer is done, this configuration prints nearly continuously and has two constraints. The first constraint is that each object should be scanned before it leaves the field of view of the last heat source or set of heat sources. The second constraint is that each group of objects, called a sector, should all finish their assigned scanning at the scan regions they are in before the sectors move the subsequent scan regions.

Scan regions which contain heat sources are called active regions whereas those without any heat sources are called empty regions. For example, in the dual laser rotary system of FIG. 1, the fields of view of the heat sources do not cover the build plate. Thus, each sector passes through several empty regions between the first and last active regions. Two assumptions are made to simplify the problem for this system configuration. The first is that the spatial size of the scan regions and sectors are identical, while the second is that each sector travels instantly between scan regions. Therefore, a sector is always fully coincident with exactly one scan region, and the unique pairs of coincident sectors and scan regions are called positions.

Example: Imagine objects {O₁, O₂, O₃, O₄} with scan times {3, 4, 1, 2} and lasers {l₁, l₂} which are configured so that there are two adjacent active regions and which each contain a single laser. The first active region contains {l₁} while the second contains {l₂}. Thus, any object not printed by {l₁} may be printed by {l₂}. Now, imagine {O₁} is on the first sector, {O₂} and {O₃} are both on the next sector, and {O₄} is on the third and final sector. If the loads were naively balanced using a greedy approach, the resulting subsets to be scanned would be {O₁, O₄} and {O₂, O₃} which have corresponding scan times of {3, 2} and {4, 1}. However, since {O₂} and {O₃} are on the same sector, the minimum total time would be 7. This time could be achieved by having {l₂} scan {O₁} while {l₁} scans {O₂} and {O₃}. Afterwards, {l₂} then prints {O₄}. The actual minimum time would be achieved by having {l₂} scan {O₁} while {l₁} scans {O₂}. Afterwards {l₂} scans {O₃} while {l₁} scans {O₄} giving a total time of six. Here, naively applying an algorithm akin to Greedy Number Partitioning results in a solution roughly 17% worse than the ideal solution.

### Methodology

### A.1 Discrete Approach

One way to approach the load balancing problem is by considering the distribution of scan times associated with the objects. Dealing with the problem in this manner requires the use of heuristics, as mentioned above, to determine the assignment of objects to heat sources. In more complex system cases, such as the Spatially Complex or Spatially Completely Overlapping without Temporal Overlap configurations, two crucial factors should be considered for proper load balancing: determining the heat sources capable of scanning an object and identifying the aspects that should be balanced.

### A.1.1 Spatially Complex

In the Spatially Complex system configuration, each object that is completely encompassed by the field of view of a heat source can be scanned by that heat source. Additionally, in these systems, since each layer is scanned independently, load balancing is about minimizing the maximum total time a heat source may scan for. This equates to balancing the total time each heat source may be scanning. As previously mentioned, since each object cannot be assigned to any heat source, traditional heuristics for partition problems do not suffice.

One previously mentioned heuristic, Greedy Number Partitioning, is essentially a two-step process. In the first step, it decides which set to add a number to, and in the second step, it determines which number to add. The more complex Karmarkar-Karp Heuristic involves the repeated creation of intermediate numbers, which are based on differences between some of the original numbers, to be used in deciding how to distribute the original numbers. Here, a four-step process is described, which includes the creation of two sets of intermediate numbers as follows: Step 1: Create a set of intermediate numbers for each unassigned object, where each number is equal to the scan times of the original objects divided by the number of possible heat sources each object can be scanned by. Step 2: Create another set of intermediate numbers for each heat source, where each number is equal to the total sum of scan times already assigned to the heat source, plus all the intermediate numbers from Step 1 associated with objects that could still be assigned to the heat source. Step 3: Find the intermediate number from Step 2 with the lowest value and its associated heat source. Step 4: Assign to the heat source from Step 3 whichever object (scannable by the heat source) has the highest scan time.

To complete the algorithmic description, it should be noted that once an object is assigned to a heat source, it is no longer considered. Likewise, once there are no more objects that can be assigned to a heat source, the heat source is no longer considered.

A.1.2 Spatially Completely Overlapping without Temporal Overlap

In the Spatially Completely Overlapping without Temporal Overlap system configurations, all objects encounter all heat sources but at potentially different times. As previously mentioned, all sectors should finish their assigned scanning for the scan regions they are in before the sectors move to the subsequent scan regions. This means that unlike the layer-by-layer configurations, where load balancing happens within layers (since all objects on a layer may finish scanning before the next layer begins), load balancing for these system configurations should be between sectors at every position. However, since objects in a sector may be printed within different scan regions and thus, at different positions, this problem becomes uniquely difficult. Another way to put this is that load balancing for these system configurations involves distributing objects between subsets which are separate from the subsets which should have their total scan time balanced together.

Here, a five step process is described which involves the creation of three sets of intermediate numbers as follows. Step 1: Create a set of intermediate numbers, for each unassigned object, equal to the scan times of the original objects divided by the number of possible heat sources each object can be scanned by. Step 2: Create another set of intermediate numbers, for each heat source at each position, equal to the total scan times assigned to each heat source plus all objects from Step 1 which could still be assigned to the heat source. Step 3: Create a final set of intermediate numbers, for each heat source at each position, equal to the number created in Step 2 minus the average of the numbers created in Step 2 for each position. Step 4: Find which intermediate number from Step 3 has the lowest value and its associated heat source. Step 5: Assign to the heat source from Step 4 whichever object has the highest scan time.

Just like before, once an object is assigned to a heat source, it is no longer considered. Likewise, once there are no more objects which can be assigned to a heat source, the heat source is no longer considered. It should be noted that this five step process and the four step process for the Spatially Complex system configuration are quite similar with only one real difference. This difference consists of Step 3 which directly stems from the attempting to balance across many separate positions simultaneously.

Since powder bed AM parts may have thousands or more layers in a part, with each layer including many unique positions, simultaneously considering the linking between all sectors and positions may be intractable. For this reason, it also beneficial to also consider load balancing on many different subsets of these positions. The approaches for balancing the full build vs balancing many smaller subsets are called the full-balancing and partial-balancing approaches respectively.

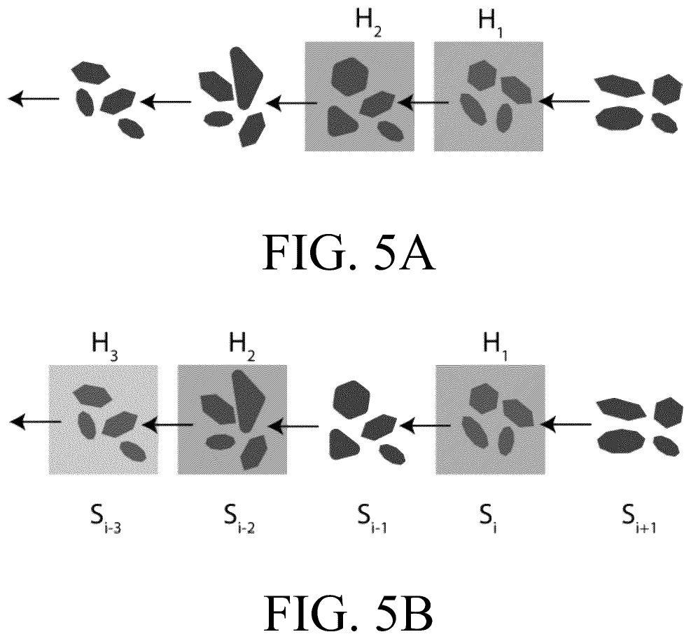

The only difference between the full-balancing and partial-balancing approaches is that the latter only load balances a subset of the positions at a time. This subset of positions is determined by calculating the connectivity using a recursive algorithm that utilizes the base connectivity between sectors and the active regions. To determine the connectivity for when N=i+1, all numbers from the base connectivity (N=1) are added to each number from the connectivity when N=i. The resulting unique numbers from this process are defined as the connectivity for when N=i+1. The base connectivity (N=1) is defined as the offsets of each active region from the first active region. When N=0, the connectivity is simply 0, indicating that only the current position is considered for load balancing. Example connectivity calculations for the configurations presented in FIG. 5 are given in TABLE 2.

TABLE 2

| A | | B | |
|---|---|---|---|
| N | Connectivity | N | Connectivity |
| 0 | 0 | 0 | 0 |
| 1 | 0-1 | 1 | 0-2-3 |
| 2 | 0-1-2 | 2 | 0-2-3-4-5-6 |
| 3 | 0-1-2-3 | 3 | 0-2-3-4-5-6-7-8-9 |

TABLE 2 shows the connectivities for the different configurations presented in FIG. 5 for different look ahead numbers.

The depth of the recursive algorithm is controlled by a hyperparameter n called the look ahead number. The look ahead number determines which sectors should be balanced with the sectors in the current position based on the future positions. Since load balancing should be applied to all positions, the process continues until every position is included in at least one subset. The most straightforward approach is to iteratively apply load balancing to all subsets starting with each position, although other more efficient methods also exist. Additionally, this entire process can be repeated multiple times, introducing the final hyperparameter G called the global repeats.

Example: To illustrate why connectivity calculations are recursive, their relationship to the configurations, and how they are determined, let's consider the configuration from FIG. 5A. In this case, determining which objects from Sᵢ should be scanned in R₁ or R₂ requires knowledge of how the objects from Sᵢ₊₁ will be scanned. This is because the position where objects from Sᵢ are scanned in H₂ is the exact same position where objects from Sᵢ₊₁ are scanned in H₁. Consequently, determining how to scan the objects in Sᵢ₊₁ necessitates knowledge of how the objects from S₁₊₂ should be scanned, leading to a recursive relationship.

### A.2 Continuous Approach

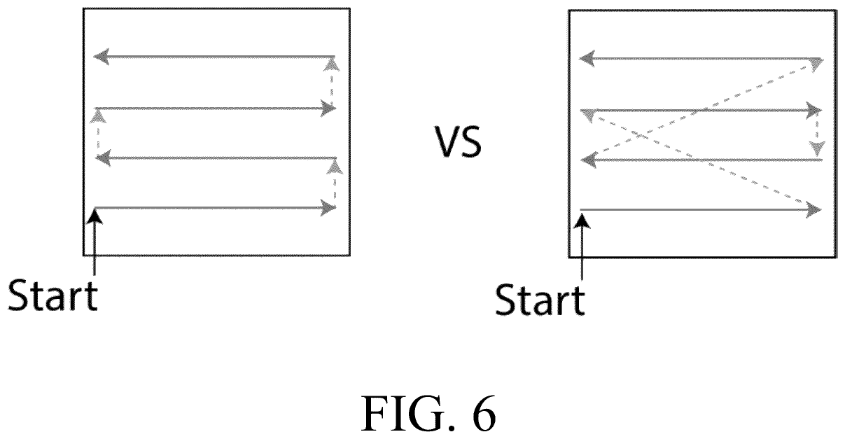

Another approach to load balancing relies on the fact that the objects themselves are comprised of many individual scan segments whose individual scan times are on the same order of magnitude. However, attempting to load balance using a heuristic-based approach on the scan times of individual scan segments introduces two issues. First, the number of iterations required by a heuristic approach would significantly increase. Instead of using a heuristic to determine the balancing of potentially hundreds of objects, it would need to determine the balancing of potentially hundreds of thousands of scan segments. Secondly, a heuristic approach would not be effective because the Timing Estimation includes the time required to jump between scan segments. Therefore, if the scan segments are not scanned in the same order, the Timing Estimation is no longer valid. This concept is illustrated in FIG. 6.

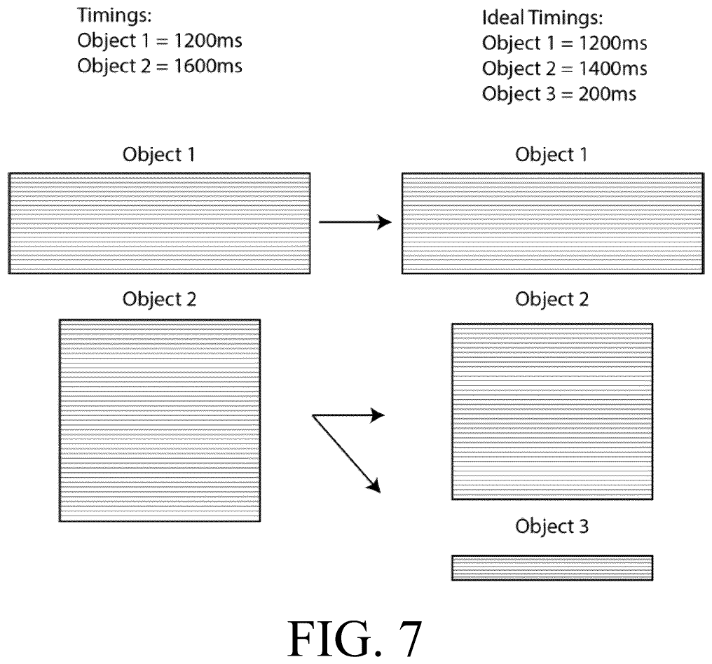

When employing the continuous approach, the emphasis of the load balancing problem shifts from determining which scan segments should be scanned in specific active regions to deciding where each object should be cut. In this context, “cutting” refers to dividing an object into two or more objects while maintaining the order of their scan segments, thereby preserving the validity of timing estimations. FIG. 7 illustrates an idealized representation of this process.

The performance of the continuous approach primarily relies on determining where the objects are cut, which is, in turn, determined by the optimal allocation of scan time to each heat source. The ideal scan time for each heat source can be iteratively determined by solving a constrained optimization problem. The problem formulation for a full build is represented by mathematical equation (1), where t*_{s,h,p} denotes the ideal scan time distribution for object s allocated to heat source h at position p.

The first constraint in this problem ensures that no time is allocated for an object to heat sources at positions where the object is not in the heat source's field of view. This constraint is expressed by mathematical equation (2), where ⊙ denotes element-wise multiplication, and A_{s,h,p} is the connectivity matrix that specifies which heat source h at position p can scan objects. The second constraint ensures that the total allocated scan time for an object remains equal to the object's total scan time, as depicted in mathematical equation (3). The final constraint (mathematical equation (4)) ensures that each time distribution is physically valid.

$${t}_{s , h , p}^{*} = {min}_{{t}_{s , h , p}} ( {\sum }_{p} {max}_{h} ( {\sum }_{s} {t}_{s , h , p} ) ) \qquad ( 1 )$$

$${\sum }_{s , h , p} ( ( 1 - {A}_{s , h , p} ) ⊙ {t}_{s , h , p} ) = 0 \qquad ( 2 )$$

$${\sum }_{h , p} ( {t}_{s , h , p} ) = {T}_{s} \qquad ( 3 )$$

$$0 \leq {t}_{s , h , p} \leq {T}_{s} \qquad ( 4 )$$

### A.2.1 Spatially Complex

The continuous approach to load balancing in Spatially Complex configurations can be simplified by exploiting the independence of each position or layer. As a result, the constrained optimization problem can be decomposed into a series of separate optimizations, with each layer having its own specific constrained optimization. These layer-specific constrained optimizations adhere to the structure illustrated in mathematical equations (5)-(8).

$${t}_{s , h}^{*} = {min}_{{t}_{s , h}} ( {max}_{h} ( {\sum }_{s} {t}_{s , h} ) ) \qquad ( 5 )$$

$${\sum }_{s , h} ( ( 1 - {A}_{s , h} ) ⊙ {t}_{s , h} ) = 0 \qquad ( 6 )$$

$${\sum }_{h} ( {t}_{s , h} ) = {T}_{s} \qquad ( 7 )$$

$$0 \leq {t}_{s , h} \leq {T}_{s} \qquad ( 8 )$$

If every element in A_{s,h}, is equal to one, the constraint in mathematical equation (6) is no longer applicable, resulting in an equivalent problem to load balancing on a Spatially Completely Overlapping configuration. In this case, the solution is simply to evenly distribute the scan time of each object among the heat sources. However, when dealing with Spatially Complex configurations, the constraint remains, making the solution more involved. One approach to finding a solution involves iteratively improving t_{s,h}. To simplify the subsequent mathematical expressions, mathematical equation (9) introduces a notation for broadcasting an array X to shape (a, b). Broadcasting is performed by intelligently replicating an array along one or more new axes until it matches the desired shape. This concept is similar to the functionality provided by the Python class numpy.broadcast.

$${X}_{\to ( a , b )} = numpy \cdot broadcast\_to ( X , ( a , b ) ) \qquad ( 9 )$$

The chosen iterative method is described by mathematical equations (10)-(12). Mathematical equation (10) introduces the intermediate variable t′, which represents the difference between the time allocated to each heat source and the average time distributed to the heat sources, where H is the total number of heat sources. Subsequently, mathematical equation (11) constructs t″ based on t′, ensuring that the update to the timings (mathematical equation (12)) using t″ satisfies the constraint specified in mathematical equation (7). In mathematical equation (12), α is a hyperparameter which balances the speed of convergence and the stability of the iterative method. At the end of each iteration, any time distributions that fall outside the specified bounds (mathematical equation (8)) are adjusted. Specifically, these distributions are set to the nearest bound, with the difference evenly distributed among the time distributions that are not at either bound. This process is repeated until no time distributions are found to be outside the bounds.

$${t}_{s , h}^{′} = {A}_{s , h} ⊙ {( {\sum }_{s} {t}_{s , h} - \frac{1}{H} {\sum }_{s , h} {t}_{s , h} )}_{\to ( s , h )} \qquad ( 10 )$$

$${t}_{s , h}^{″} = {A}_{s , h} ⊙ ( {t}_{s , h}^{′} - {( \frac{{\sum }_{h} {t}_{s , h}}{{\sum }_{h} {A}_{s , h}} )}_{\to ( s , h )} ) \qquad ( 11 )$$

A.2.2 Spatially Completely Overlapping without Temporal Overlap

The continuous approach to load balancing on these system configurations can be further simplified, as each object encounters each heat source, albeit at different positions. Moreover, since the configuration is static, the offset between the positive values in the connectivity matrix remains the same for every object. This can be mathematically represented by equation 14, where B represents the position at which an object first encounters a heat source, and C(h) represents the positional offset from the first heat source to heat source h, similar to the Connectivity calculations shown in section 4.1.2. It is important to note that B is defined to be zero for negative indices.

$${A}_{s , p} = {\sum }_{h} ( {B}_{s , p - C ( h )} ) \qquad ( 13 )$$

$${\sum }_{p} ( {B}_{s , p} ) = 1 \qquad ( 14 )$$

Additionally, the problem can be approached differently by directly solving for the ideal timing distributed to each heat source in each position, denoted as t*_{h,p} rather than determining the timing for each object to be scanned in each position, denoted as t*_{s,p}. While this framing does not simplify the constrained optimization problem (mathematical equations (15)-(18)), it serves the practical purpose of reducing the number of required cuts. This reduction in cuts improves real-world load balancing, as illustrated in the example below.

Example: Let's consider objects {O₁, O₂} with scan times {4, 6}, and lasers {l₁, l₂}, configured such that all lasers can scan all objects. If we approach the problem by considering how the time for each object will be distributed, we might assign t_{1,h}=[2, 2] and t_{2,h}=[3, 3], resulting in a total scan time of 5 for each laser. However, an alternative approach can achieve the same total scan time with t_{1,h}=[4, 0] and t_{2,h}=[1, 5]. The first method involves two cuts, while the second method requires only a single cut. Reducing the number of cuts improves the final real-world result because cuts are made at the ends of scan segments, which have quantized times. Additionally, minimizing the number of cuts helps to decrease the number of inter-object jumps that the heat sources may make during the scanning process.

$${t}_{h , p}^{*} = {min}_{{t}_{\text{?} , p}} ( {max}_{h} ( {\sum }_{\text{?}} {t}_{h , p} ) ) \qquad ( 15 )$$

$${\sum }_{h , p} ( ( 1 - {A}_{h , p} ) ⊙ {t}_{h , p} ) = 0 \qquad ( 16 )$$

$${\sum }_{h} ( {t}_{h , p} ) = {T}_{h} \qquad ( 17 )$$

$$0 \leq {t}_{h , p} \leq {T}_{h} \qquad ( 18 )$$

$$\text{?} \text{indicates text missing or illegible when filed}$$

To iteratively solve for the ideal time allocated to each heat source in the continuous approach, we can use a similar process as described above. This involves introducing intermediate variables to facilitate the optimization. Mathematical equation (19) creates the intermediate variable t′, which represents the difference between the time allocated to heat source h at position p and the average time allocated to heat sources in positions where an object in view of heat source h at position p would encounter the other heat sources. Mathematical equation (20) then constructs t″ based on t′, ensuring that the update to the timings (mathematical equation (21)) using t″ satisfies the constraint given by mathematical equation (17). In mathematical equation (21), a is a hyperparameter which balances the speed of convergence and the stability of the iterative method.

At the end of each step, a technique similar to the previous sections is followed to ensure that no times assigned to a heat source are less than zero or greater than the maximum possible time. Also, just like in the above discussion relating to spatially complex configurations, either a full-balancing or partial-balancing approach can be taken. Additionally, two hyperparameters are introduced which control the number of iterations taken for a given subset of positions (s) as well as the total number of global iterations (G).

$${t}_{h , p}^{′} = {t}_{h , p} - \frac{1}{H} {\sum }_{h} ( {t}_{h , p + C ( h )} ) \qquad ( 19 )$$

$${t}_{h , p}^{″} = {t}_{h , p}^{′} - \frac{1}{H} {\sum }_{h} ( {t}_{h , p}^{′} ) \qquad ( 20 )$$

$${t}_{h , p} ← {t}_{h , p} - α {t}_{h , p}^{″} \qquad ( 21 )$$

### Results

### Discrete

The approximation ratio is a valuable metric for comparing the quality of heuristics and is defined as the largest sum in a heuristic's output divided by the largest sum in an optimal partition. It is important to note that finding the exact approximation ratio for a heuristic does not make sense as it depends on the distribution of numbers. However, in some cases, it is possible to derive the worst-case approximation ratio mathematically, although such derivations can be complex even for basic heuristics used in the multiway number partitioning problem. Since deriving the worst-case approximation ratio for heuristics described herein is beyond its scope, a numerical approach is employed instead.

### Spatially Complex

Numerically determining the approximation ratio involved conducting one hundred iterations on randomly initialized setups. These setups were designed to ensure that each heat source, under ideal balancing conditions, would receive an equal amount of assigned scan time. The construction of these setups involved using a set of hyperparameters that controlled the number of heat sources (numHeat), the number of objects (maxObj), the distribution of scan times for these objects (maxRatio), and the connectivities between objects and heat sources (minConn and maxConn).

The setups used in the numerical analysis, as listed in TABLE 3, exhibit increasing complexity. It is important to note that in the case of G1, where both minConn and maxConn are equal to the number of heat sources, the problem is equivalent to load balancing on a Spatially Completely Overlapping configuration and can therefore be approached as a multiway number partitioning problem. On the other hand, G2 does not guarantee that every object can be assigned to every heat source. Both G3 and G4 increase complexity by increasing the number of heat sources, while G4 also investigates the impact of maxRatio on the approximation ratio of the selected heuristics.

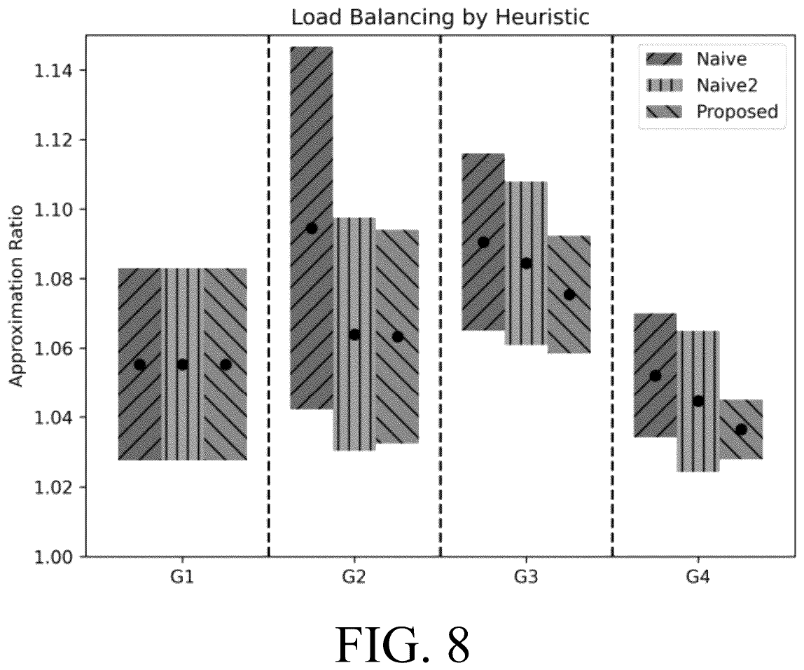

FIG. 8 compares three heuristics: Naive, Naive2, and Proposed. Both Naive and Naive2 are straightforward extensions of the greedy partition algorithm, while Proposed is the heuristic. The Naive heuristic selects the object with the largest scan time and assigns it to the heat source with the lowest scan time, excluding heat sources to which the object cannot be assigned. On the other hand, the Naive2 heuristic works in the opposite way. It first identifies the heat source with the lowest scan time and then assigns the largest object that can be assigned to it. Once a heat source has no remaining objects that can be assigned to it, it is no longer considered.

FIG. 8 provides an illustration showing the average, as denoted by the black dot, and standard deviation of the approximation ratios for the configurations listed in TABLE 3.

TABLE 3

| Setup | numHeat | minConn | maxConn | maxObj | maxRatio | avObj |
|---|---|---|---|---|---|---|
| G1 | 4 | 4 | 4 | 8 | 4 | 16 |
| G2 | 4 | 1 | 4 | 8 | 4 | 16 |
| G3 | 16 | 4 | 16 | 8 | 4 | 54 |
| G4 | 16 | 4 | 16 | 16 | 8 | 63 |

TABLE 3 shows what various hyperparameters are set to for the various configurations and resulting average total objects for these configurations (avObj).

The results depicted in FIG. 8 demonstrate several key findings. Firstly, as the connectivity of the system becomes more complex, the proposed heuristic consistently outperforms both straightforward extensions. This suggests that the proposed heuristic is better equipped to handle intricate system structures and achieve more balanced load distributions. Secondly, among the two greedy heuristics, Naive2 consistently outperforms Naive in terms of the approximation ratio. This indicates that the reverse approach employed by Naive2, where the heat source with the lowest scan time is selected first, yields better load balancing results compared to assigning the object with the largest scan time to the heat source with the lowest scan time. Furthermore, the standard deviation of the approximation ratio for the proposed heuristic is noticeably smaller than that of the greedy heuristics. This implies that the proposed heuristic provides more consistent and reliable load balancing outcomes across different setups and configurations. Interestingly, in the case of G1, all three heuristics perform identically, indicating that Proposed is a more performant extension of the greedy heuristic than either Naive or Naive2 for the type of partition problem encountered when load balancing these system configurations.

Spatially Completely Overlapping without Temporal Overlap

Numerically determining the approximation ratio on these system configurations was done by iterating over two setups {T1, T2}, but with differing values for the look ahead number (n). The two setups both have {maxObj, maxRatio}={10, 4}, four heat sources per active sector, and two-hundred different positions. The difference between the two setups lies in base connectivity which are {0-5, 0-3-5} for configurations {T1, T2}. Therefore, configuration T2 is considered more complex.

Here, both the Naive and Naive2 heuristics from the previous section are identical because the connectivities of all objects are the same. Additionally, the value of n has no impact since the Naive heuristic, which does not include a step similar to Step 3 from the above subsection relating to Spatially Completely Overlapping without Temporal Overlap system configurations, will always incrementally balance from the first to the last position.

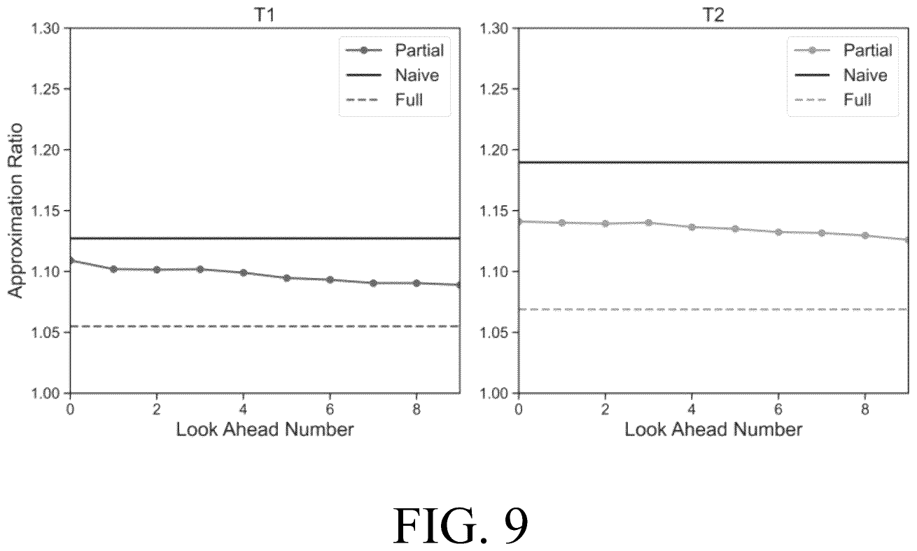

The results presented in FIG. 9 demonstrate that increasing the value of n leads to a decrease in the approximation ratio. Even with n=0, which represents balancing only the current position, the proposed heuristic outperforms the Naive approach. However, even for relatively large values of n, the proposed heuristic is still significantly outperformed by the full-balancing approach. It is worth noting that when n=10, approximately half of the build is balanced at a time.

### Continuous

The continuous approach can be evaluated using the same metrics as the heuristic approach, where an approximation ratio of one indicates perfect balancing. The performance of the continuous approach is influenced by two factors: the scan time of individual scan segments relative to the scan time of objects, and the effectiveness of the iterative algorithms used. In general, the scan time of scan segments is comparable to each other, and the number of scan segments in an object is typically in the hundreds. With these assumptions, it is reasonable to expect a loss in performance of up to 1% depending on where an object is cut. This loss in performance is in addition to any approximation ratio that the iterative algorithm converges to.

### Spatially Complex

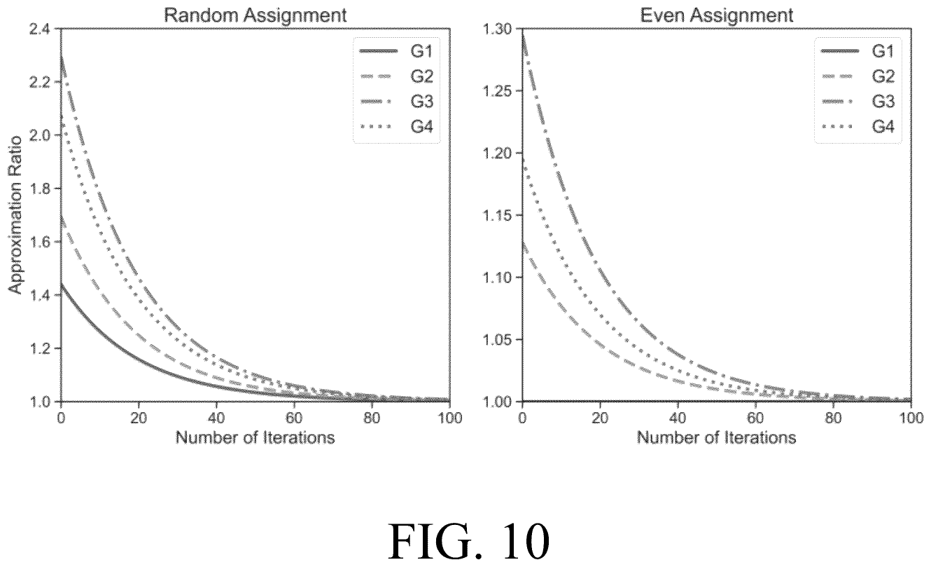

Using an iterative method to load balance Spatially Complex configurations results in asymptotically approaching perfect load balancing, regardless of the initial allocation of scan times. This behavior strongly hints at the problem being convex in nature. To illustrate this, FIG. 10 showcases the convergence of the approximation ratio as a function of the iteration for two different initial conditions: (1) randomly assigning the scan time for an entire object to one possible heat source; and (2) assigning an even amount of scan time, for each object, to each possible heat source. It should be noted that the speed of convergence of the problem is dependent on the learning rate, and the learning rate used in the creation of FIG. 10 is overly conservative and is solely used for illustrative purposes.

Spatially Completely Overlapping without Temporal Overlap

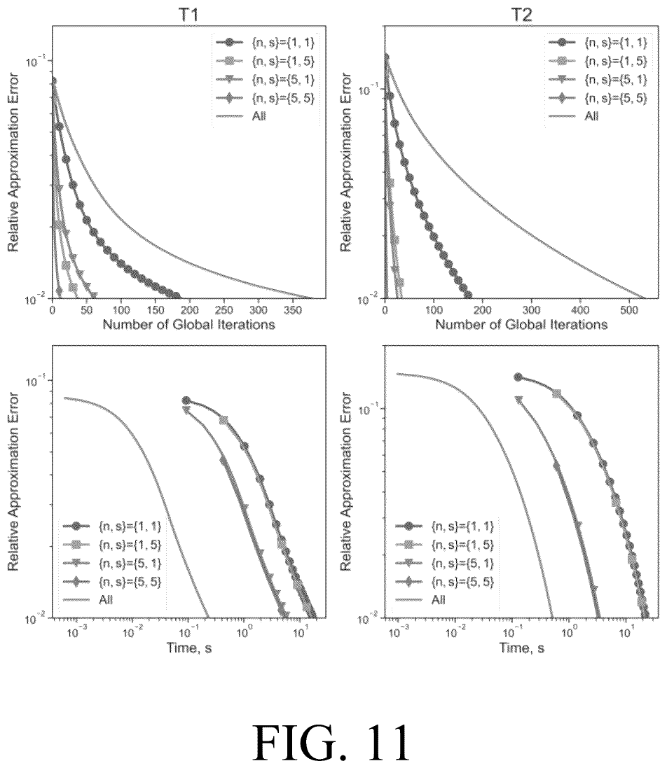

Using an iterative method to load balance these configurations also results in asymptotically approaching perfect load balancing. FIG. 11 examines the relative approximation error, defined as the approximation ratio minus one, as a function of both the global iteration G and time for several different values for the look ahead number n and number of partial iterations s. The initial distribution of scan times used here comes from an even assignment. As before, the learning rate is intentionally set to be small for illustrative purposes.

As expected, larger values for both n and s lead to achieving the same accuracy with fewer global iterations, with s having a larger effect than n. However, the key takeaway is that increasing s has no effect on the time required to achieve the same accuracy, while increasing n results in decreased computational time, with full-balancing, as shown by “All” in the figure, requiring the least time. This suggests that n should be kept as large as possible, without running into memory constraints, to maximize the speed of the algorithm.

### Real World Application

To provide a more practical demonstration, the load balancing algorithms described herein were applied to example builds designed and sliced for the rotary powder bed system. This system's configuration represents a Spatially Completely Overlapping without Temporal Overlap configuration with two heat sources positioned opposite each other, as depicted in FIG. 1. The temporal connectivity of the sectors is determined by the number of sectors created per layer during the slicing process, which is a user-defined hyperparameter.

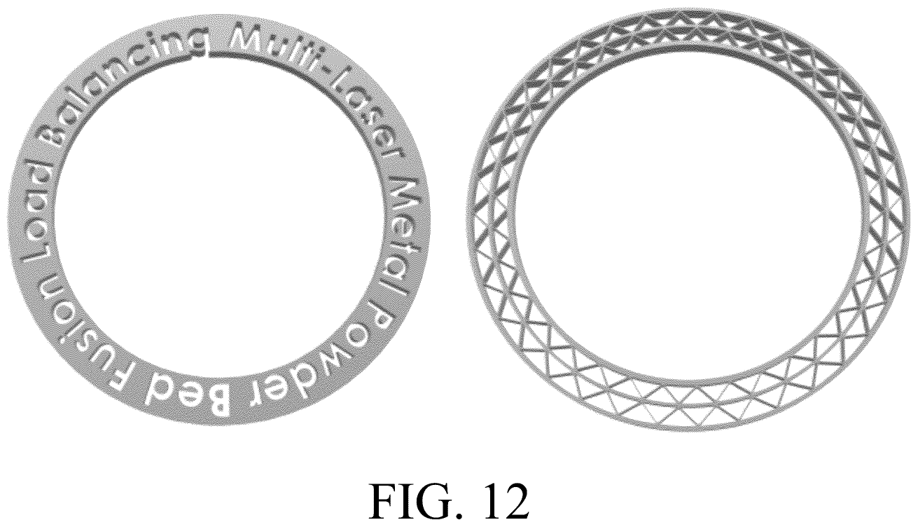

To test the load balancing algorithms on real-world scenarios, solid 3D models were sliced and selected as representative examples, as shown in FIG. 12. This allows for a practical evaluation of the algorithms' effectiveness in achieving load balancing in a realistic manufacturing setting.

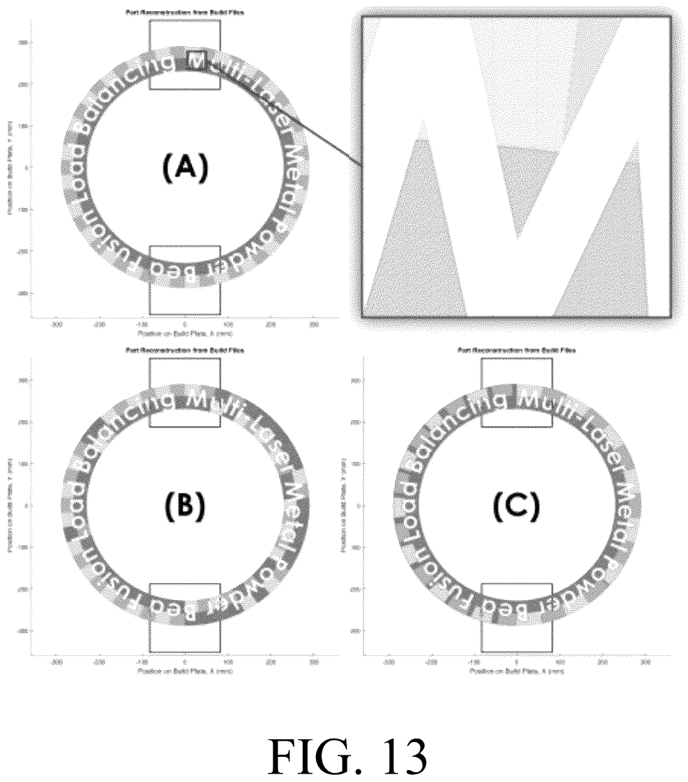

Here, the number of sectors per layer is taken to be fifty. FIG. 13 shows an example of the cross-sections for the ‘Text ring” model. The hatch angle is alternated at 670 for each layer. Each sector consists of two objects, which are derived from a single object cut at a constant radius from the center of the build. By default, the objects further from the center are assigned to be scanned by the heat source at the top of the system, while the other objects are scanned by the heat source at the bottom of the system.

Accurately estimating the time required to execute a set of instructions from a Common Layer Interface (CLI) file is crucial for load balancing, with the algorithm used for timing estimation being machine specific. In the case of the rotary powder bed system described herein, timing estimation is performed by calculating the laser marking time. This calculation necessitates knowledge of not only the primary printing parameters, such as scan speed, but also a comprehensive understanding of all the scanner marking parameters, including laser on or off delay, mark delay, jump delay, polygon delay, and others. These parameters are carefully adjusted to achieve high-quality laser marking performance.

All the scan patterns employed in this system include either polyline perimeters or regions of alternating hatch infill, which can be further subdivided into individual scan segments. These scan segments can be categorized as linear scan segments (laser on) or jump segments (laser off). For each scan segment, it is assumed that the laser spot begins with an initial velocity of zero and accelerates at a constant rate until it reaches the desired scan speed or reaches the end of the segment. The total scan time for a part is determined by summing the times required to complete each of its individual scan segments.

It is evident from the areas of the objects (FIG. 13A) that the default assignment is inefficient. Assuming that the scan time is proportional to the scan area, cutting a cylinder in this way results in a Relative Approximation Error of roughly 3%. This means that the actual scan time deviates from the ideal scan time by 3%. However, it is important to note that the actual timings for the scan segments assigned to an area may not necessarily be proportional to that area. Furthermore, when dealing with more complex systems that involve multiple heat sources and scan areas, relying solely on visualization and intuition will not be sufficient for efficient load balancing.

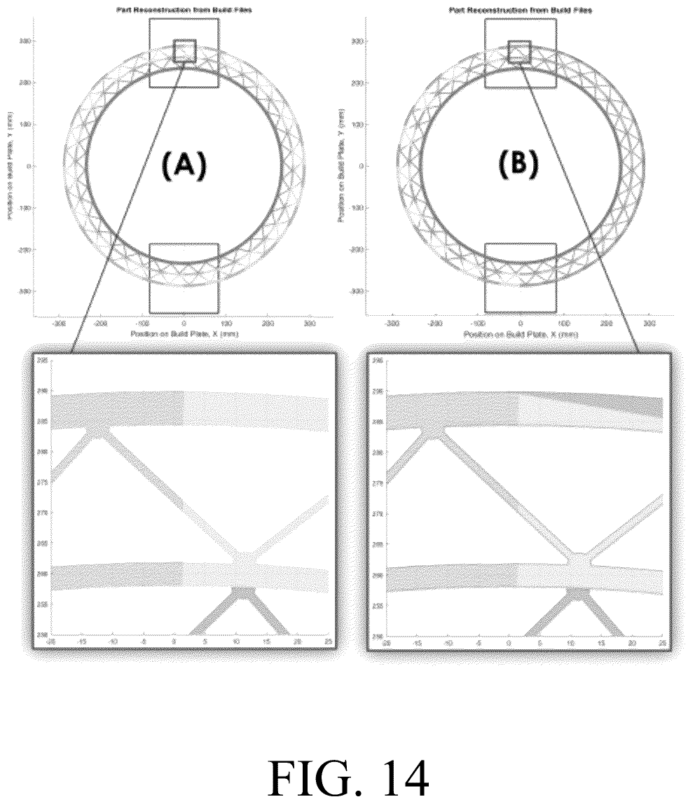

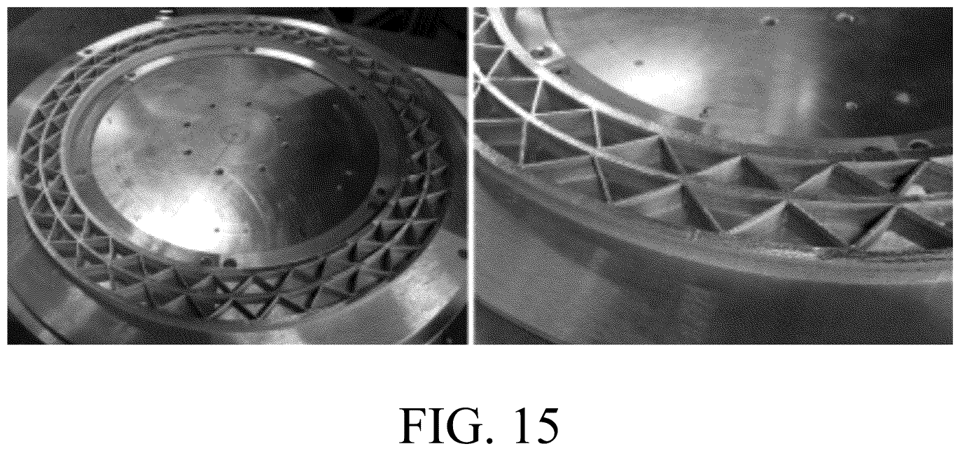

Nevertheless, the real-world geometries considered are more complex than a simple cylinder, and the resulting assignments for both the discrete and continuous approaches (shown in FIG. 13 and FIG. 14) are not intuitively derived. However, these assignments lead to a significant reduction in print time. For the text ring geometry, the default assignment takes approximately 133 minutes and 15 seconds to print. By applying the discrete approach, the build time is reduced by approximately 5.7%, and with the continuous approach, the build time is reduced by nearly 8.2%. In the case of the lattice ring geometry, the continuous approach achieves an impressive 11% reduction in build time. The lattice ring geometry was printed on the rotary powder bed system and the resulting part is illustrated in FIG. 15.

Although the continuous approach results in better load-balancing than any discrete approach, including those which use heuristics not yet discovered, there are reasons to use both methods. The discrete approach offers the advantage of preserving the integrity of the objects by not cutting them up. This ensures that any optimized scan strategy (micro-structure control, defect minimization, etc.) remains intact, making it a load-balancing approach without drawbacks. On the other hand, the continuous approach excels in maximizing throughput. However, when an object is cut, there is no guarantee that the original optimized scan strategy will retain its intended functionality. In some industry applications where minor defects are acceptable, the continuous approach may be the method of choice.

Additionally, the algorithms described herein are designed to be “future-proof.” While it is possible that better heuristics may be discovered in the future, these algorithms were developed to handle both current and next-generation additive manufacturing systems. As throughput requirements increase, it becomes necessary to incorporate more heat sources. The algorithms demonstrated in the results section perform well even on arbitrarily complex system configurations. Furthermore, both algorithms exhibit excellent computational performance and can efficiently handle complex system configurations. Load balancing for the build discussed above in relation to a real world application takes less than five seconds despite containing roughly two hundred thousand sectors (and thus millions of scan segments). This is achieved even using a single-threaded, unoptimized Python implementation. Therefore, these algorithms offer not only robust performance for current systems but also the scalability and efficiency required for anticipated advancements in additive manufacturing technologies.

The computational speed of these algorithms leads to an interesting application for improving system robustness. As systems become more intricate and add more heat sources, the likelihood that a heat source fails during a build increases. In the event of a fail, these algorithms could be used to quickly rebalance the loads to the remaining heat sources. Such an implementation may be integrated with the machine to determine exactly which heat sources fail and when. Then the already scanned objects and scan segments can be removed from consideration.

Interposition load balancing can be readily achieved, on systems which read in CLI files, by rebalancing and rewriting these files for positions not yet encountered. If this is done on a Spatially Completely Overlapping without Temporal Overlap configuration and the time it takes to full-balance the remaining build takes too long, partial-balancing, which is quicker to compute, can be done instead for the next few immediate positions before switching to full-balancing. This approach works because balancing a build takes much less time than printing a build.

Intra-position load balancing would be more difficult to implement but is likely okay to neglect since the effect on the overall print time would be negligible compared to inter-position load balancing as long as heat source failures are sufficiently uncommon. If intra-position load balancing is neglected and a heat source fails, some implementation should be made to ensure the rest of the objects or scan segments assigned to that heat sources end up getting printed. Nevertheless, the technologies described herein can form the backbone of any algorithm based approach for either inter-position or intra-position on-the-fly load balancing.

Two methods for load balancing multi-beam additive manufacturing systems were developed, aiming to increase system throughput. The first method is described above in relation to Discrete Approach section of this document. The first method approaches the problem by treating it as a collection of discrete objects with associated scan times and utilizes heuristics. The first method ensures that objects are kept together, preserving any optimized scan strategies specific to those objects. The second method is described above in relation to the Continuous Approach section of this document. The second method treats objects as having the ability to distribute their associated scan time among multiple heat sources, using iterative approaches to find the optimal time distribution. This method involves cutting the objects, which may result in the loss of intended scan behavior for the original objects, but it achieves the highest throughput. Both of these methods were used on an example geometry printed on the rotary powder bed system and achieved speedups over the default scan assignment of 5.7% and 8.2% respectively.

These methods are not only “future-proof” and capable of operating on theoretically complex next-generation systems, but they are also computationally efficient when implemented. This introduces the potential to enhance system robustness by enabling on-the-fly load balancing in the event of heat source failures. An algorithm for on-the-fly load balancing is feasible. The methods described herein can serve as the foundation for any such algorithm. As systems become more complex and incorporate additional heat sources to increase throughput, manual methods for load balancing and dealing with heat source failures become impractical. Therefore, the methods described herein can become increasingly valuable as additive manufacturing system configurations continue to evolve.

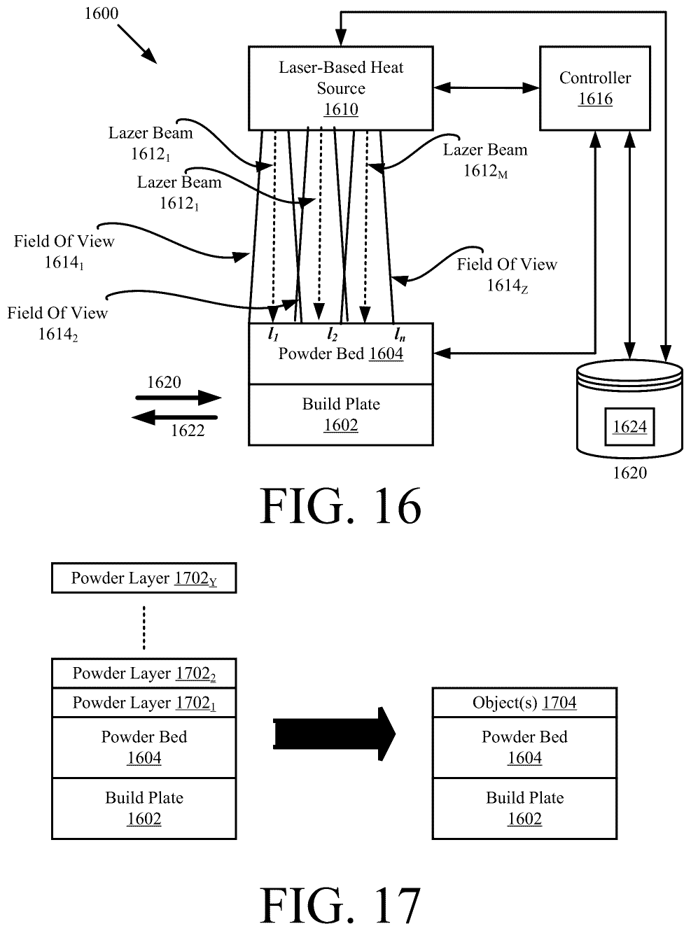

FIG. 16 provides a block diagram of an illustrative system 1600 implementing the present solution. System 1600 is configured to use laser beams to form objects by fusing layers of metal powder. In this regard, system 1600 comprises a build plate 1602, a powder bed 1604, a laser-based heat source 1610, and a controller 1616. Build pates, powder beds, and laser-based heat sources are known. Any known or to be known build pate, powder bed and/or laser-based heat source can be used here. The controller 1616 can include, but is not limited to, a computing device, a field programmable gate array (FPGA), an application specific circuit (ASIC), a processor, a microprocessor, and/or other circuit.

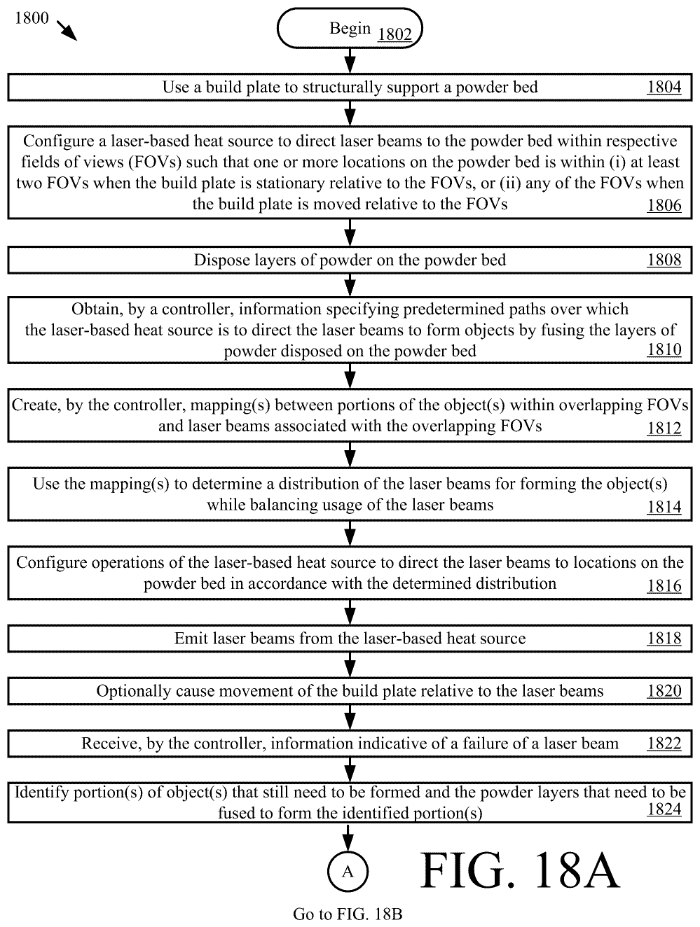

The build plate 1602 is configured to structurally support the powder bed 1604. The metal powder is selectively deposited onto the powder bed 1604 during an automated manufacturing process for forming object(s). The metal powder is deposed in layers. For example, as shown in FIG. 17, powder layers 1702₁, 1702₂, . . . , 1702_{Y} are deposited on the powder bed in a layer-by-layer manner. Y can be any number greater than one. The stacked powder layers 1702₁, 1702₂, . . . , 1702_{Y} are used to form object(s) 1704. The object(s) 1704 may be two-dimensional or three-dimensional objects.

The laser-based heat source 1610 is configured to direct laser beams 1612₁, 1612₂, . . . , 1612_{M} to the powder bed 1604 within respective FOVs. M can be any number greater than or equal to two. The laser beams are directed to the powder bed 1604 such that at least one location (e.g., location l₁, l₂ and/or l₃) on the power bed 1604 is to be within (i) at least two FOVs (e.g., FOV 1612₁, 1612₂, . . . , and/or 1612_{Z}) when the build plate 1602 is held stationary relative to the FOVs, or (ii) any of the FOVs (e.g., FOV 1612₁, 1612₂, . . . , 1612_{Z}) when the build plate 1602 is moved relative to the FOVs.

The controller 1616 is configured to: obtain information indicative of, at least, predetermined paths over which the laser-based heat source 1610 is to direct the laser beams 1612₁, 1612₂, . . . , 1612_{M} to form objects 1704 by fusing the powder along the predetermined paths; determine a distribution of the laser beams 1612₁-1612_{M} for forming at least corresponding portions of the object(s) 1704 while balancing usage of the laser beams 1612₁-1612_{M}; and instruct the heat source to direct the laser beams 1612₁-1612_{M} to locations on the powder bed 1604, at least in part, in accordance with the determined distribution. The distribution may be determined by creating two or more mappings between portions of the object(s) 1704 within overlapping FOVs (e.g., FOV 1612₁, 1612₂) and laser beams 1612₁-1612_{M} associated with the overlapping FOVs. The mappings may be created in accordance with: mathematical equations (10)-(12), while satisfying the constraints provided in mathematical equations (5)-(8); and/or mathematical equations (19)-(21), while satisfying the constraints provided in mathematical equations (13)-(18).

In some scenarios, the number of laser beams directed by the laser-based heat source 1610 to the powder bed 1604 may be greater than or equal to three. In response to receiving information indicative of failure of one of the laser beams, the controller 1616 is configured to: identify portions of some of the object(s) 1704 that are still to be formed by the remaining M−1 laser beams; and redetermine, by recreating the mappings, the distribution of the remaining M−1 laser beams for forming at least corresponding portions of the identified still-to-be-formed portions of the object(s) 1704.

The build plate 1602 may be configured to be held stationary relative to the FOVs 1612₁, 1612₂, . . . , 1612_{Z} during operation of system 1600. The controller 1616 may be configured to create the mappings by (1) performing operations described above in relation to in the Spatially Complex system configuration of section A.1.1, without cutting any of the object(s) 1704 or (2) by performing operations described in relation to in the Spatially Complex system configuration of section A.2.1, while cutting at least some of the object(s) 1704.

Additionally, or alternatively, the build plate 1602 is configured to be moved relative to the FOVs 1612₁, 1612₂, . . . , 1612_{Z} during operation of system 100. The controller 1616 may be configured to create the mappings by (1) performing operations described in section A.1.2. without cutting any of the objects 1704, or (2) performing operations described in section A.2.2. while cutting at least some of the objects 1704.

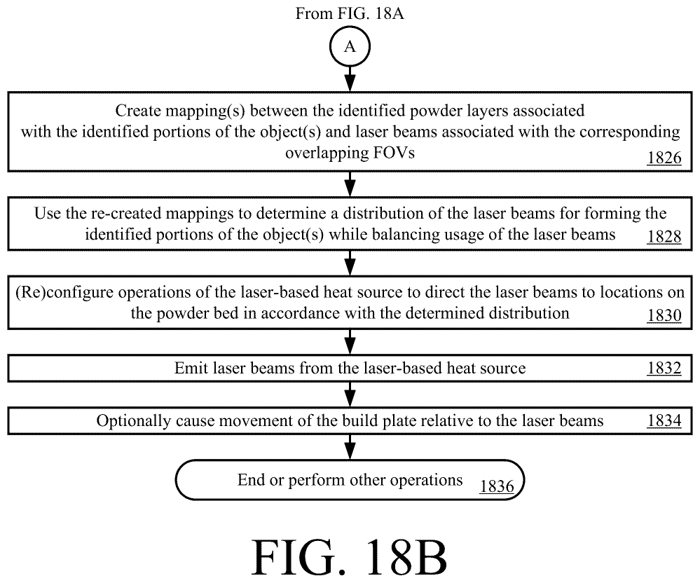

FIG. 18 provides a flow diagram of an illustrative method 1800 for operating a system (e.g., system 1600 of FIG. 16) for performing an additive manufacturing process to form object(s) (e.g., object(s) 1704 of FIG. 17). The operations of blocks 1804-1834 can be performed in the same or different order than that shown. For example, the operations of block 1808 can be performed before the operations of block 1806.

Method 1800 begins with block 1802 and continues to block 1804 where a build plate (e.g., build plate 1602 of FIG. 16) is used to structurally support a powder bed (e.g., powder bed 1604 of FIG. 16). Next in block 1806, a laser-based heat source (e.g., laser-based heat source 1610 of FIG. 16) is configured to direct laser beams (e.g., laser beams 1612₁-1612_{M} of FIG. 16) to the powder bed within respective FOVs (e.g., FOV(s) 1614i-1614_{Z} of FIG. 16) such that any location on the powder bed is within (i) at least two FOVs when the build plate is stationary relative to the FOVs, or (ii) any of the FOVs when the build plate is moved relative to the FOVs. In block 1808, layers of powder (e.g., powder layers 1702₁-1702_{Z} of FIG. 17) are disposed on the powder bed. Any known or to be known technique for depositing powder on a surface can be used here.

As shown in block 1810, a controller (e.g., controller 1616 of FIG. 16) performs operations to obtain information specifying predetermined paths over which the laser-based heat source is to direct the laser beams to form the object(s) by fusing the layers of powder disposed on the powder bed. These operations can include, but are not limited to: receiving information from the laser-based heat source; and/or accessing a datastore (e.g., datastore 1620 of FIG. 16) and retrieving data (e.g., data 1624 of FIG. 16) from the datastore.

The controller creates mapping(s) between portions of the object(s) within FOVs (which may or may not be overlapping) and laser beams associated with the overlapping FOVs, as shown by block 1812. For example, the controller creates a mapping in which a first portion of a first object within overlapping FOVs 1614₁, 1614₂ is mapped to (or otherwise associated with) laser beams 1612₁, 1612₂, and a mapping in which a second portion of the first or second object within overlapping FOVs 1614₂, 1614_{N} are mapped to (or otherwise associated with) laser beams 1612₂, 1612_{M}. The present solution is not limited to the particulars of this example. The mappings can be created: by performing operations described above in relation to section A.1.1 or section A.2.1 without cutting any of the object(s); in accordance with mathematical equations (10)-(12) while satisfying constraints of mathematical equations (5)-(8); or in accordance with mathematical equation(s) (19)-(21) while satisfying constraints provided by mathematical equation(s) (13)-(18).

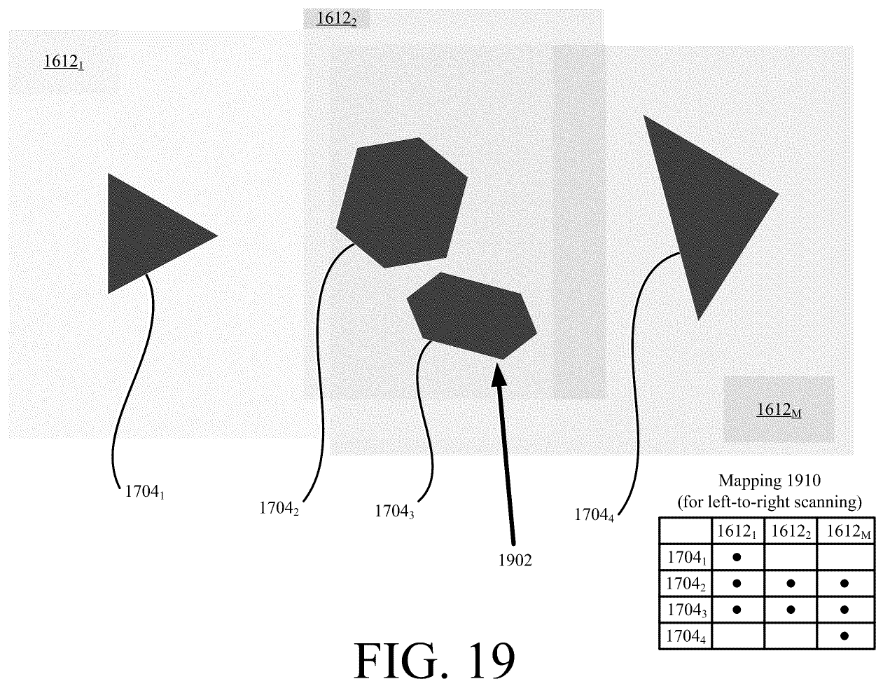

An illustration is provided in FIG. 19 that is useful for understanding the mapping operation of block 1812. In FIG. 19, four objects 1704₁, 1704₂, 1704₃, 1704₄ are to be formed using three laser beams 1612₁, 1612₂, 1612_{M}. Each laser beam scans from left to right. Laser beam 1612₁ can scan objects 1704₁, 1704₂, 1704₃. Laser beam 1612₂ can scan objects 1704₂, 1704₃. Laser beam 1612_{M} can scan objects 1704₂, 1704₃, 1704₄. So, illustrative mappings can be defined as shown in the table of FIG. 19. The present solution is not limited to the particulars of this scenario.

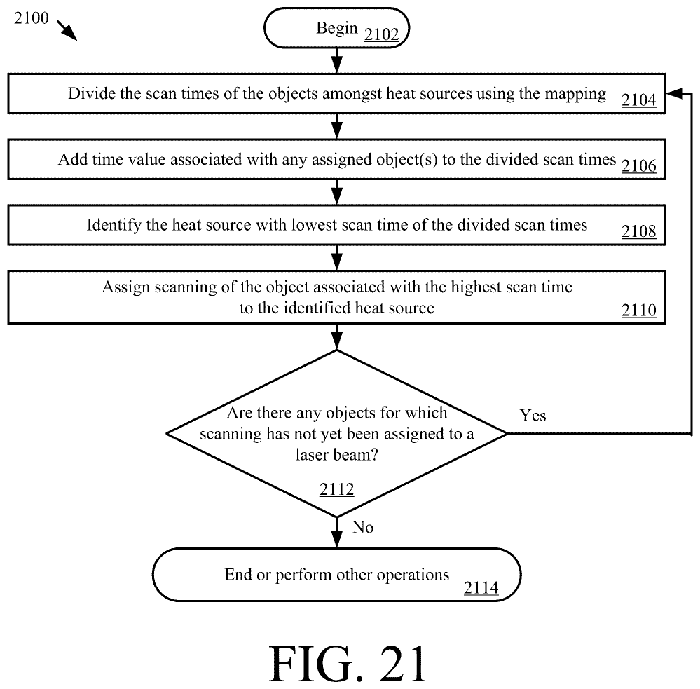

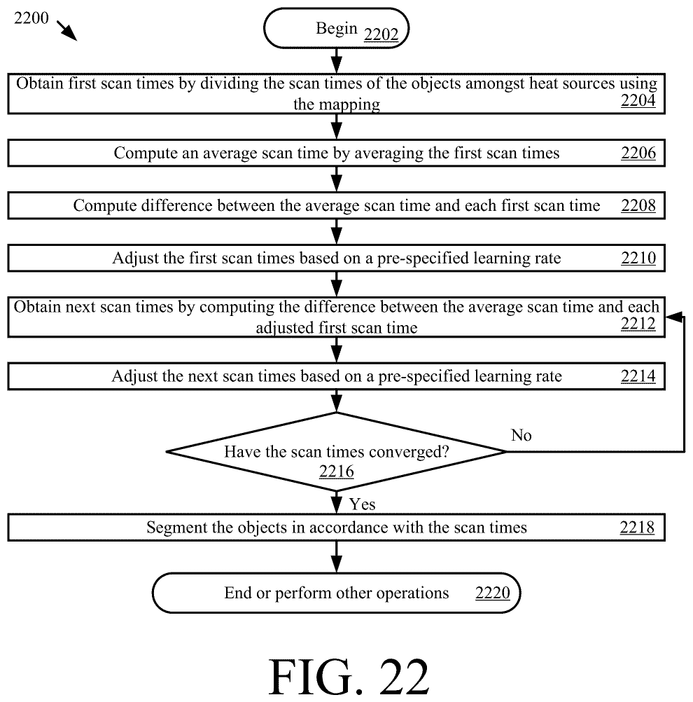

In block 1814, the controller uses the mappings to determine a distribution of the laser beams for forming the object(s) while balancing usage of the laser beams. The manner in which this determination is made will be discussed in detail below in relation to FIGS. 21 and 22. The controller then configures the laser-based heat source to direct the laser beams to locations on the powder bed in accordance with the determined distributions, as shown by block 1816.

In block 1818, the laser-based heat source emits the laser beams. The build plate may be optionally moved in one or more directions (e.g., directions 1620 and/or 1622 of FIG. 16) relative to the laser beams, as shown by block 1820.

In block 1822, the controller receives information indicative of a failure of a laser beam. For example, the information indicates that laser beam 1612₂ of FIG. 19 has failed. Thus, laser beams 1612₁ and 1612_{M} are the only operational laser beams of the three laser beams. The present solution is not limited to this example. In response to this information, the controller performs operations in block 1824 to identify portion(s) of the object(s) that still need to be formed and identify the powder layers that need to be fused to form the identified object(s). For example, the controller identifies that the right-half 1902 of object 1704₃ still needs to be formed, and the entire object 1704₄ needs to be formed. The present solution is not limited in this regard. Upon completing the operations of block 1824, method 1800 continues to block 1826 of FIG. 18B.

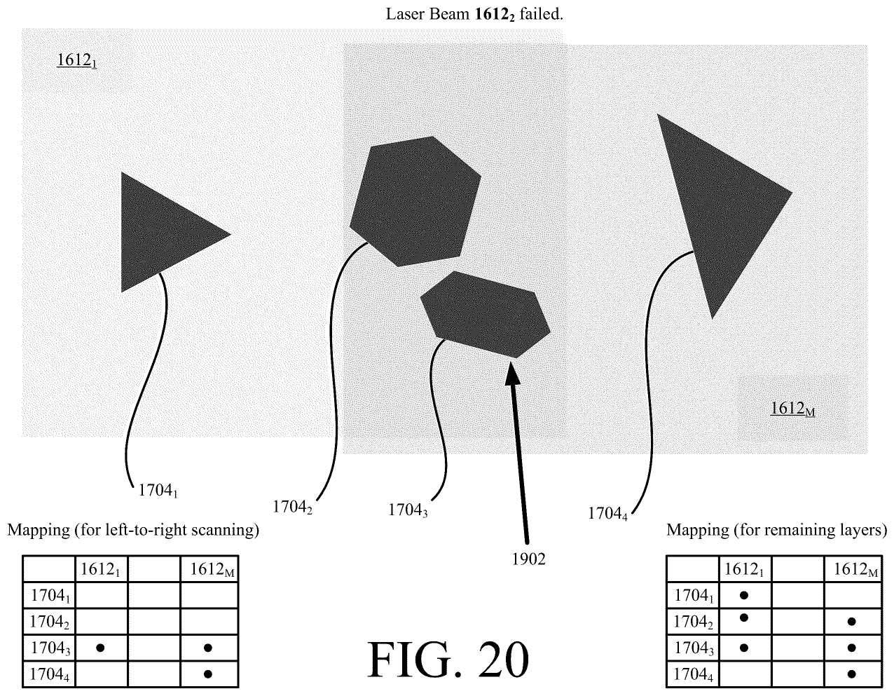

As shown in FIG. 18B, block 1826 involves re-create mapping(s) between the identified powder layers associated with the identified portion(s) of the object(s) and the laser beams associated with the corresponding overlapping FOVs. In FIG. 20, the right-half 1902 of object 1704₃ and the entire object 1704₄ still need to be formed using the remaining laser beams 1612₁, 1612_{M}. Each laser beam scans from left to right. Laser beam 1612₁ can scan objects 1704₃. Laser beam 1612_{M} can scan objects 1704₃, 1704₄. So, illustrative mappings can be defined as shown in the table of FIG. 20. The present solution is not limited to the particulars of this scenario.

The re-created mappings are used in block 1828 to determine a distribution of the laser beams for forming the identified portions of the object(s) while balancing usage of the laser beams. This distribution can be determined in the same or similar manner as that described above in relation to block 1814.

Operations of the laser-based heat source are reconfigured in block 1830 to direct the laser beams to locations on the powder bed in accordance with the distribution determined in block 1828. The laser-based heat source emits the laser beams in block 1832. Movement of the build piece may be optionally caused relative to the laser beams, as shown by block 1834. Subsequently, method 1800 continues to block 1836 where it ends or other operations are performed.

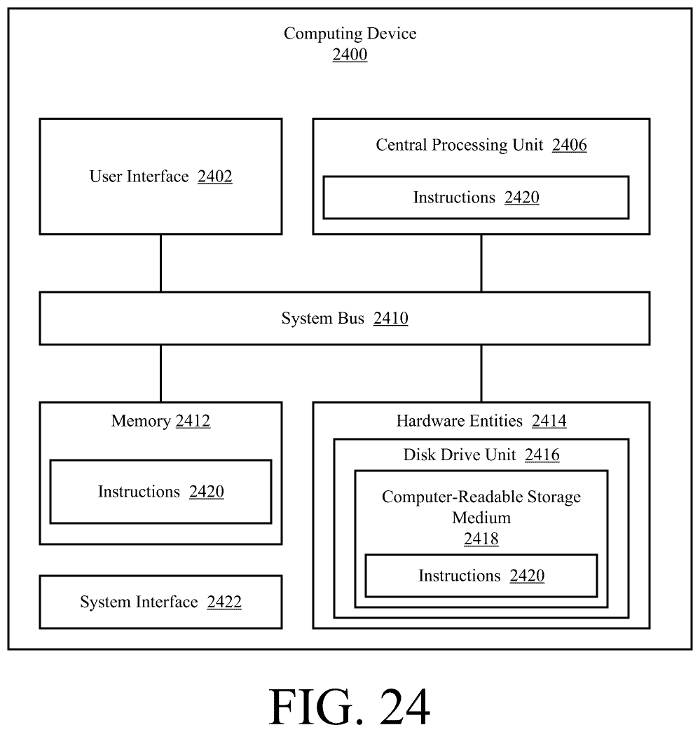

FIG. 21 provides a flow diagram of an illustrative method 2100 for determining a distribution of laser beams for forming object(s). Some or all of the operations of method 2100 can be performed by a system (e.g., system 1600 of FIG. 16), a controller (e.g., controller 1616 of FIG. 16), a computing device (e.g., computing device 2400 of FIG. 24), a processor (e.g., processor 2406 of FIG. 24), and/or other device.

Method 2100 begins with 2102 and continues with the operations of blocks 2104-2110. The operations involve: (2104) dividing the scan times amongst the heat sources using the mapping; (2106) adding a time value associated with any assigned object(s) to the divided scan times; (2108) identifying the heat source with the lowest scan time of the divided scan times; and (2110) assigning scanning of the object associated with the highest time to the identified heat source. Next in block 2112, a decision is made as to whether there are any objects for which scanning has not yet been assigned to a laser beam. If so [2112:YES], then method 2100 returns to 2104 so that a next iteration of process is performed. If not [2112:NO], then method 2100 continues to block 2114 where it ends or other operations are performed.

Method 2100 will now be described in relation to an illustrative scenario. In this scenarios, there are four objects 17041, 1704₂, 1704₃, 1704₄ and three heat sources 1612₁, 1612₂, 1612m. The objects 17041, 1704₂, 1704₃, 1704₄ have respective scan times of [4, 5, 2, 6]. Heat source 1612₁ can scan objects 17041 (scan time of 4), 1704₂ (scan time of 5), and 1704₃ (scan time of 2). Heat source 1612₂ can scan objects 1704₂ (scan time of 5) and 1704₃ (scan time of 2) Heat source 1612M can scan objects 1704₂ (scan time of 5), 1704₃ (scan time of 2), and 1704₄ (scan time of 6).

The discrete approach of FIG. 21 will now be described in relation to this scenario. During a first iteration, block 2104 involves divide the scan times of the objects 17041, 1704₂, 1704₃, 1704₄ amongst heat sources using a previously created mapping. An illustrative mapping is shown in the following TABLE 4, where a one value means that the object can be scanned by the laser beam and a zero value means the object is not able to be scanned by the laser beam.

TABLE 4

| | 1612₁ | 1612₂ | 1612_{M} |
|---|---|---|---|
| 1704₁ | 1 | 0 | 0 |
| 1704₂ | 1 | 1 | 0 |
| 1704₃ | 1 | 1 | 0 |
| 1704₄ | 0 | 0 | 1 |

As shown in TABLE 4, object 1704₁ can only be scanned by heat source 1612₁. So, the scan time for object 1704₁ is given to heat source 1612₁ (i.e., [4, 0, 0]). Object 1704₂ can be scanned by all heat sources. So, the scan time for object 1704₂ is divided evenly amongst the three heat sources (i.e., [5/3, 5/3, 5/3]). Object 1704₃ can be scanned by all three heat sources. So, the scan time for object 1704₃ is divided evenly between heat sources (i.e., [⅔, ⅔, ⅔]). Object 1704₄ can only be scanned by heat source 1612_{M}. So, the scan time for object 1704₄ is given to this heat source 1612m (i.e., [0, 0, 6]). The resulting times for the heat sources are:
for heat source 1612₁→4+5/3+⅔+0=12/3+5/3+⅔+0/3=19/3;
for heat source 1612₂→0+5/3+⅔+0=0/3+5/3+⅔+0/3=7/3;
for heat source 1612_{M}→0+5/3+⅔+6=0/3+5/3+⅔+18/3=25/3.
   So, the divided heat source scan times are [19/3, 7/3, 25/3].

In block 2106, [0, 0, 0] is added to the divided scan times [19/3, 7/3, 25/3] since none of the objects have been assigned to the laser beams yet.

In block 2108, the heat source with the lowest time of the divided scan times [19/3, 7/3, 25/3] is identified. In this case, heat source 1612₂ has the lowest time of 7/3.

In block 2110, scanning of the object associated with the highest time is assigned to the identified heat source 1612₂. In this case, object 1704₂ is assigned to heat source 1612₂ since it is associated with the highest scan time of the two objects 1704₂, 1704₃ that were mapped to heat source 1612₂. (i.e., a scan time of 5 is greater than a scan time of 2).

Upon completing this scanning assignment, a next iteration of the process is performed. In this second iteration, block 2104 involves dividing the scan times of the remaining unassigned objects 1704₁, 1704₃, 1704₄ amongst the heat sources. Object 1704₁ can only be scanned by heat source 1612₁. So, the scan time for object 1704₁ is given to heat source 1612₁ (i.e., [4 or 12/3, 0/3, 0/3]). Object 1704₃ can be scanned by all heat sources. So, divide its time evenly between the heat sources (i.e., [⅔, ⅔, ⅔]). Object 1704₄ can only be scanned by heat source 1612_{M}. So, the scan time for object 1704₄ is given time to this heat source 1612_{M} (i.e., 0/3, 0/3, 6 or 18/3]). The resulting times for the heat sources are:
for heat source 1612₁→12/3+⅔+0/3=14/3;
for heat source 1612₂→0/3+⅔+0/3=⅔; and
for heat source 1612_{M}→0/3+⅔+18/3=20/3.
   So, the divided heat source scan times are [14/3, ⅔, 20/3].

Block 2106 involves adding [0, 5 or 15/3, 0] to the resulting scan times [14/3, ⅔, 20/3] to get scan times [14/3, 17/3, 20/3].

Block 2108 involves identifying the heat source with the lowest scan time of scan times [14/3, 17/3, 20/3]. In this case, heat source 1612₁ has the lowest time of 14/3.

Block 2110 involves assigning scanning of the object associated with the highest scan time to the identified heat source 1612₁. In this case, object 1704₁ is assigned to heat source 1612₁ since it is associated with the highest scan time of values the two remaining objects 1704₁, 1704₃ that were mapped to heat source 1612₁. (i.e., a scan time of 4 is greater than a scan time of 2).

Upon completing the second iteration, a decision is made to optionally perform more iterations. Other iteration(s) is(are) performed until there are no objects remain for which scanning is to be assigned to a laser beam.

FIG. 22 provides a flow diagram of another illustrative method 2200 for determining a distribution of laser beams for forming object(s). Some or all of the operations of method 2200 can be performed by a system (e.g., system 1600 of FIG. 16), a controller (e.g., controller 1616 of FIG. 16), a computing device (e.g., computing device 2400 of FIG. 24), a processor (e.g., processor 2406 of FIG. 24), and/or other device.

Method 2200 begins with 2202 and continues with the operations of block 2204-2214. These operations involve: (2204) obtaining first scan times by dividing the scan times of the objects amongst heat sources using the mapping; (2206) computing an average scan time by averaging the first scan times; (2208) computing the difference between the average scan time and each first scan time; (2210) adjusting the first scan time based on a per-specified learning rate; (2212) obtaining next scan times by computing the difference between the average scan time and each adjusted scan time; and (2214) adjusting the next scan times based on a pre-specified learning rate. Upon completing the operations of block 2214, a decision is made as to whether the scan times have converged. If not [2216:NO], then method 2200 returns to 2212. Otherwise [2212:YES], method 2200 continues to block 2218 where the objects are segmented in accordance with the scan times. Thereafter, methods 2200 ends or other operations are performed in block 2220.

Method 2200 will now be described in relation to an illustrative scenario. In this scenarios, there are four objects 1704₁, 1704₂, 1704₃, 1704₄ and three heat sources 1612₁, 1612₂, 1612m. The objects 1704₁, 1704₂, 1704₃, 1704₄ have respective scan times of [4, 5, 2, 6]. Heat source 1612₁ can scan objects 1704₁ (scan time of 4), 1704₂ (scan time of 5), and 1704₃ (scan time of 2). Heat source 1612₂ can scan objects 1704₂ (scan time of 5) and 1704₃ (scan time of 2) Heat source 1612M can scan objects 1704₂ (scan time of 5), 1704₃ (scan time of 2), and 1704₄ (scan time of 6).

The continuous approach of FIG. 22 will now be described in relation to this scenario. During a first iteration, block 2204 involves divide the scan times of the objects 1704₁, 1704₂, 1704₃, 1704₄ amongst heat sources using a previously created mapping. The mapping could be a two dimensional (2D) mapping or three dimensional (3D) mapping. An illustrative 2D mapping is shown in the following TABLE 5, where a one value means that the object can be scanned by the laser beam and a zero value means the object is not able to be scanned by the laser beam. This 2D mapping can be modified to be a 3D mapping by adding a third dimension. The third dimension can include, but is not limited to, scanning positions of objects at various scanning times.

TABLE 5

| | 1612₁ | 1612₂ | 1612_{M} |
|---|---|---|---|
| 1704₁ | 1 | 0 | 0 |
| 1704₂ | 1 | 1 | 1 |
| 1704₃ | 1 | 1 | 0 |
| 1704₄ | 0 | 0 | 1 |

As shown in TABLE 5, object 1704₁ can only be scanned by heat source 1612₁. So, the scan time for object 1704₁ is given to heat source 1612₁ (i.e., [4, 0, 0]). Object 1704₂ can be scanned by all heat sources. So, the scan time for object 1704₂ is divided evenly amongst the three heat sources (i.e., [5/3, 5/3, 5/3]). Object 1704₃ can be scanned by all three heat sources. So, the scan time for object 1704₃ is divided evenly between heat sources (i.e., [⅔, ⅔, ⅔]). Object 1704₄ can only be scanned by heat source 1612_{M}. So, the scan time for object 1704₄ is given to this heat source 1612m (i.e., [0, 0, 6]). The resulting scan times for the heat sources are:

for heat source 1612₁ → 4 + 5/3 + 2/3 + 0 =
12/3 + 5/3 + 2/3 + 0/3 = 19/3;
for heat source 1612₂ → 0 + 5/3 + 2/3 + 0 =
0/3 + 5/3 + 2/3 + 0/3 = 7/3;
for heat source 1612_{M} → 0 + 5/3 + 2/3 + 6 =
0/3 + 5/3 +2/3 + 18/3 = 25/3.
So, the divided heat source scan times are [19/3, 7/3, 25/3].

Block 2206 involves computing an average scan time Avgsr by averaging scan times [19/3, 7/3, 25/3]. In the present case, the average scan time is computed as follow.

$${Avg}_{ST} = ( 19 + 7 + 25 ) / 3 ) / 3 = ( 51 / 3 ) / 3 = 17 / 3$$

Block 2208 involves computing the difference D of each scan time from the average scan time. The differences are computed as follows.

$${D}_{1612 - 1} = 19 / 3 - 17 / 3 = 2 / 3$$

$${D}_{1612 - 2} = 7 / 3 - 17 / 3 = - 10 / 3$$

$${D}_{1612 - M} = 25 / 3 - 17 / 3 = 8 / 3$$

So, the resulting differences are [⅔, −10/3, 8/3].

Block 2210 involves adjusting the times based on a pre-specified learning rate. The pre-specified learning rate can have a value, for example, between zero and one. For example, the learning rate is selected to be 1/2. Then, the adjusted first scan times are computed as follows.

$$[ 19 / 3 , 7 / 3 , 25 / 3 ] - 1 / 2 * [ 2 / 3 , - 10 / 3 , 8 / 3 ] = [ 6 , 4 , 7 ]$$

Block 2212 involves obtaining next scan times by computing the difference between the average scan time and each adjusted first scan time. The next set of differences are computed as follows.

for heat source 1612₁ → 6 − 17/3 = 1/3
for heat source 1612₂ → 4 − 17/3 = −5/3
for heat source 1612_{M} → 7 − 17/3 = 4/3
So, the resulting differences are [1/3, −5/3, 4/3].

Block 2214 involves adjusting the scan times [⅓, −5/3, 4/3] based on the pre-specified learning rate. The pre-specified learning rate can be the same as that used in block 2210. For example, the learning rate is selected to be 1/2. Then, the adjusted next scan times are computed as follows.

$$[ 19 / 3 , 7 / 3 , 25 / 3 ] - 1 / 2 * [ 1 / 3 , - 5 / 3 , 84 / 3 ] = [ 35 / 6 , 29 / 6 , 19 / 3 ]$$

Upon completing the operations of block 2214, a decision is made in block 2216 to optionally perform next iterations of block 2212-2214. Other iteration(s) is(are) performed until the scan times have converged or otherwise have not changed much.

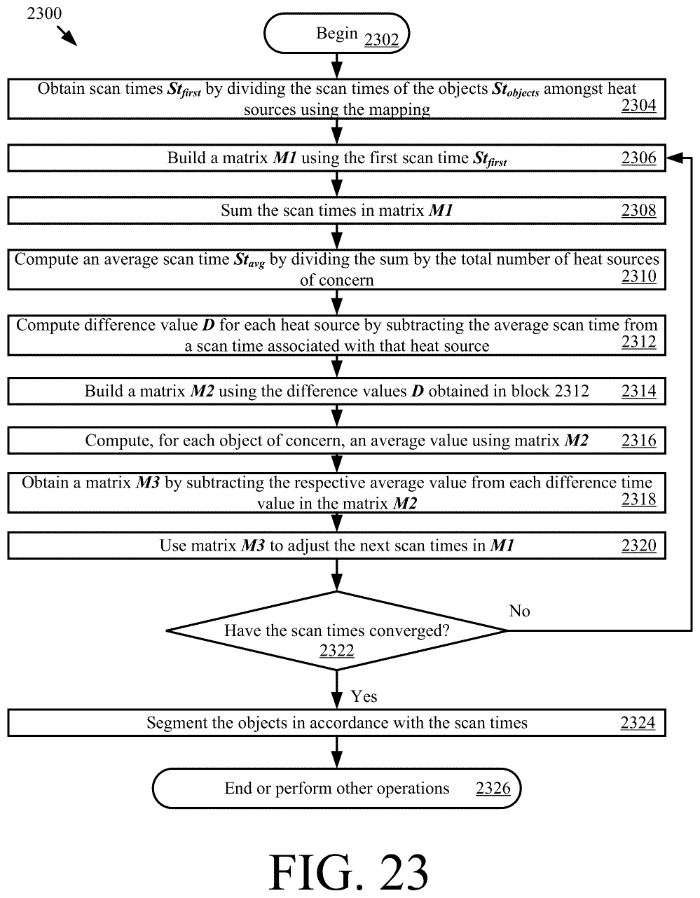

FIG. 23 provides an illustration of another method 2300 for determining a distribution of laser beams for forming object(s). Method 2300 illustrates an implementation of method 2200 using matrix based mathematics. Some or all of the operations of method 2300 can be performed by a system (e.g., system 1600 of FIG. 16), a controller (e.g., controller 1616 of FIG. 16), a computing device (e.g., computing device 2400 of FIG. 24), a processor (e.g., processor 2406 of FIG. 24), and/or other device.

Method 2300 begins with 2302 and continues with the operations of block 2304 where first scan times St_{first} are obtained by dividing the scan times of the objects St_{objects} amongst heat sources using a mapping. The mapping may comprise a matrix M0 shown below.

$$[ \begin{matrix}V 1 & V 2 & V 3 \\ V 4 & V 5 & V 6 \\ V 7 & V 8 & V 9 \\ V 10 & V 11 & V 12\end{matrix} ]$$

where each variable V1-V12 has a value of one or zero. For example, the matrix may be defined as follows.

$$[ \begin{matrix}1 & 0 & 0 \\ 1 & 1 & 1 \\ 1 & 1 & 1 \\ 0 & 0 & 1\end{matrix} ]$$

Each column in the matrix M0 is associated with a respective heat source of a plurality of heat sources. In this scenario, there are three heat sources. Each row in the matrix M0 is associated with a respective object of a plurality of objects. In this scenario, there are four objects. The present solution is not limited in this regard. Any number of heat sources and/or objects can be used in accordance with a particular application. Also, the columns may be associated with the objects, while the rows are associated with the heat sources.

In block 2306, a matrix M1 is built using the first scan times St_{first}. This operation involves computing values for each row of the matrix. Such computations may be defined by the following mathematical equations. For example, in this scenario, each row includes three values. The first row includes values m1, m2 and m3. The second row includes values m4, m5 and m6. The third row includes values m7, m8 and m9. The fourth row includes values m10, m11 and m12. Accordingly, matrix M1 can be defined as shown below.

$$[ \begin{matrix}m 1 & m 2 & m 3 \\ m 4 & m 5 & m 6 \\ m 7 & m 8 & m 9 \\ m 10 & m 11 & m 12\end{matrix} ]$$

The values m1-m12 may be defined by the following mathematical equations.

$$m 1 = ( V 1 * {St}_{object - 1} ) / ( V 1 + V 2 + V 3 ) ( e . g . , m 1 = ( 1 * {St}_{object - 1} ) / ( 1 + 0 + 0 ) )$$

$$m 2 = ( V 2 * {St}_{object - 1} ) / ( V 1 + V 2 + V 3 ) ( e . g . , m 2 = ( 0 * {St}_{object - 1} ) / ( 1 + 0 + 0 ) )$$

$$m 3 = V 3 * {St}_{object - 1} ) / ( V 1 + V 2 + V 3 ) ( e . g . , m 3 = ( 0 * {St}_{object - 1} ) / ( 1 + 0 + 0 ) )$$

$$m 4 = ( V 4 * {St}_{object - 2} ) / ( V 4 + V 5 + V 6 ) ( e . g . , m 4 = ( 1 * {St}_{object - 2} ) / ( 1 + 1 + 1 ) )$$

$$m 5 = ( V 5 * {St}_{object - 2} ) / ( V 4 + V 5 + V 6 ) ( e . g . , m 5 = ( 1 * {St}_{object - 2} ) / ( 1 + 1 + 1 ) )$$

$$m 6 = ( V 6 * {St}_{object - 2} ) / ( V 4 + V 5 + V 6 ) ( e . g . , m 6 = ( 1 * {St}_{object - 2} ) / ( 1 + 1 + 1 ) )$$

$$m 7 = ( V 7 * {St}_{object - 3} ) / ( V 7 + V 8 + V 9 ) ( e . g . , m 7 = ( 1 * {St}_{object - 3} ) / ( 1 + 1 + 1 ) )$$

$$m 8 = ( V 8 * {St}_{object - 3} ) / ( V 7 + V 8 + V 9 ) ( e . g . , m 8 = ( 1 * {St}_{object - 3} ) / ( 1 + 1 + 1 ) )$$

$$m 9 = ( V 9 * {St}_{object - 3} ) / ( V 7 + V 8 + V 9 ) ( e . g . , m 9 = ( 1 * {St}_{object - 3} ) / ( 1 + 1 + 1 ) )$$

$$m 10 = V 10 * {St}_{object - 4 )} / ( V 10 + V 11 + V 12 ) ( e . g . , m 10 = ( 0 * {St}_{object - 4} ) / ( 0 + 0 + 1 ) )$$

$$m 11 = ( V 11 * {St}_{object - 4 )} / ( V 10 + V 11 + V 12 ) ( e . g . , m11 = ( 0 * {St}_{object - 4} ) / ( 0 + 0 + 1 ) )$$

$$m 12 = ( V 12 * {St}_{object - 4 )} / ( V 10 + V 11 + V 12 ) ( e . g . , m 12 = ( 1 * {St}_{object - 4} ) / ( 0 + 0 + 1 ) )$$

Next in block 2308, the scan times m1-m12 of matrix M1 are added together to obtain a sum mₛᵤₘ. An average scan time Stavg is computed in block 2310 by dividing the sum mₛᵤₘ by the total number of heat sources of concern Tₕₛ. This division operation is defined by the following mathematical equation.

$$Stavg = {m}_{s u m} / {T}_{h s}$$

In block 2312, a difference value is computed for each heat source by subtracting the average scan time Stavg from a scan time associated with that heat source. The operation of block 2312 can be defined by the following mathematical equation.

M1−Stavg

The difference values are used in block 2314 to build a matrix M2. Matrix M2 may be defined by the following mathematical equation.

$$M 2 = M 1 - Stavg * M 0$$

Matrix M2 is used in block 2316 to compute, for each object of concern, an average value. For example, an average value M2A_{row1} is computed using the values in the first row of matrix M2. An average value M2A_{row2} is computed using the values in the second row of matrix M2. An average value M2A_{row3} is computed using the values in the third row of matrix M2. An average value M2A_{row4} is computed using the values in the fourth row of matrix M2. Each average value is computed by summing the values in the respective row and dividing by the sum of the values in the respective row in matrix M0.

In block 2318, a matrix M3 is obtained by subtracting the respective average value from each time value in matrix M2. The operations of block 2318 may be defined by the following mathematical expressions.

$$M 3 row 1 = M 2 row 1 - M 2 {A}_{row 1} * M 0 row 1$$

$$M 3 row 2 = M 2 row 2 - M 2 {A}_{row 2} * M 0 row 2$$

$$M 3 row 3 = M 2 row 3 - M 2 {A}_{row 3} * M 0 row 3$$

$$M 3 row 4 = M 2 row 4 - M 2 {A}_{row 4} * M 0 row 4$$

In block 2320, matrix M3 is used to adjust the scan times in M1. The operation of block 2320 may be defined by the following mathematical expression.

$$M 1 - α * M 3 ,$$

where α represents a learning rate. It should be noted that the software code may be configured to ensure that the values of adjusted M1 for each row do not exceed the associated scan time of the object (e.g., the St_{object}) or fall below zero. Thereafter, a decision is made as to whether the scan times have converged. If not [2322:NO], then method 2300 returns to block 2306. If so [2322:YES], then method 2300 continues to block 2324 where the objects are segmented in accordance with the scan times. Subsequently, method 2300 continues to block 2326 where it ends or other operations are performed.

Referring now to FIG. 24, there is provided a block diagram of an illustrative embodiment of a computing device 2400. Controller 1616 of FIG. 16 can be the same as or similar to computing device 2400. As such, the discussion of computing device 2400 is sufficient for understanding controller 1616.

Computing device 2400 can include, but is not limited to, a notebook, a desktop computer, a laptop computer, a personal digital assistant, and a tablet PC. Some or all the components of the computing device 2400 can be implemented as hardware, software and/or a combination of hardware and software. The hardware includes, but is not limited to, one or more electronic circuits.

Computing device 2400 may include more or less components than those shown in FIG. 24. However, the components shown are sufficient to disclose an illustrative embodiment implementing the present invention. The hardware architecture of FIG. 24 represents one embodiment of a representative computing device configured to facilitate control of traffic flow along arterials in an efficient manner. As such, the computing device 2400 of FIG. 24 implements improved methods for controlling traffic flow along arterials in accordance with embodiments of the present solution.

As shown in FIG. 24, computing device 2400 includes a system interface 2422, a user interface 2402, a central processing unit (CPU) 2406, a system bus 2410, a memory 2412 connected to and accessible by other portions of computing device 2400 through system bus 2410, and hardware entities 2414 connected to system bus 2410. At least some of the hardware entities 2414 perform actions involving access to and use of memory 2412, which can be a random access memory (RAM), a disk driver and/or a compact disc read only memory (CD-ROM).

System interface 2422 allows the computing device 2400 to communicate directly or indirectly with external communication devices (e.g., laser-based heat source 1610 of FIG. 16). If the computing device 2400 is communicating indirectly with the external communication device, then the computing device 2400 is sending and receiving communications through a common network (e.g., the Internet or Intranet).

Hardware entities 2414 can include a disk drive unit 2416 comprising a computer-readable storage medium 2418 on which is stored one or more sets of instructions 2420 (e.g., software code) configured to implement one or more of the methodologies, procedures, or functions described herein. The instructions 2420 can also reside, completely or at least partially, within the memory 2412 and/or within the CPU 2406 during execution thereof by the computing device 2400. The memory 2412 and the CPU 2406 also can constitute machine-readable media. The term “machine-readable media”, as used here, refers to a single medium or multiple media (e.g., a centralized or distributed database, and/or associated caches and servers) that store the one or more sets of instructions 2420. The term “machine-readable media”, as used here, also refers to any medium that is capable of storing, encoding or carrying a set of instructions 2420 for execution by the computing device 2400 and that cause the computing device 2400 to perform any one or more of the methodologies of the present disclosure.

As evident from the above discussion, the present solution concerns a powder-bed fusion system (e.g., system 1600 of FIG. 16). The powder-bed fusion system comprises a laser-based heat source (e.g., laser-based heat source 1610 of FIG. 16) and a controller (e.g., controller 1616 of FIG. 16). The laser-based heat source is configured to direct laser beams (e.g., laser beams 1612₁, 1612₂, . . . , 1612_{M} of FIG. 16) to a powder bed (e.g., powder bed 1604 of FIG. 6) within respective FOVs such that one or more locations on the powder bed is within (i) at least two FOVs when a build plate is stationary relative to the FOVs or (ii) any of the FOVs when the build plate is moved relative to the FOVs. The controller is configured to: obtain information specifying predetermined paths over which the laser-based heat source is to direct the laser beams to form objects (e.g., object(s) 1704 of FIG. 17) by fusing layers of powder (e.g., powder layers 1702₁, 1702₂, . . . , 1702_{Y} of FIG. 17) disposed on the powder bed; create a first mapping (e.g., mapping 1910 of FIG. 19) between portions of the objects within overlapping FOVs and the laser beams associated with the overlapping FOVs; use the first mapping to determine a first distribution of the laser beams for forming the objects while balancing usage of the laser beams; and cause the laser-based heat source to direct the laser beams to locations on the powder bed in accordance with the first distribution. In this regard, the controller may communicate the first distribution to the laser-based heat source and/or communicate command signal(s) to the laser-based heat source for configuring the laser-based heat source to operate in accordance with the first distribution. The first mapping can include, but is not limited to, a two-dimensional mapping, or a three dimensional mapping with a third dimension comprising scanning positions of the objects at different scanning times.

The controller may be further configured to: (responsive to a failure of one of the laser beams) identify portion(s) of the object(s) that still(s) needs to be formed; identify layer(s) of powder that need(s) to be fused to form the identified portion(s); create a second mapping between the identified layer(s) of powder that are associated with the identified portion(s) of the object(s) and the laser beams associated with the corresponding overlapping FOVs; use the second mapping to determine a second distribution of the laser beams for forming the identified portion(s) of the object(s) while balancing usage of the laser beams; and/or cause the laser-based heat source to direct the laser beams to locations on the powder bed in accordance with the second distribution. In this regard, the controller may communicate the second distribution to the laser-based heat source and/or communicate command signal(s) to the laser-based heat source for configuring the laser-based heat source to operate in accordance with the second distribution. The second mapping can include, but is not limited to, a two-dimensional mapping, or a three dimensional mapping with a third dimension comprising scanning positions of the objects at different scanning times.

The first distribution may be determined by: dividing first scan times of the objects amongst the laser beams using the first mapping to obtain second scan times; adding a time value associated with an assigned object to the second scan times to obtain third scan times; identifying a laser beam with a lowest scan time of the third scan times; and assigning, to the identified laser beam, scanning of an object associated with a highest scan time of ones of the first scan times that are associated with ones of the objects that are able to be scanned by the identified laser beam. The operations may be repeated until all of the objects have been assigned to the laser beams.

The first distribution may alternatively be determined by: dividing first scan times of the objects amongst the laser beams using the first mapping to obtain second scan times; computing an average scan time by averaging the first scan times; computing a difference between the average scan time and each of the first scan times; and generating adjusted scan times by adjusting the first scan times based on a pre-specified learning rate. The scan time operations may be iteratively repeated. The objects may be segmented in accordance with the adjusted scan times.

The present solution also concerns implementing system and methods for operating a powder-bed fusion system. The methods comprise: configuring a laser-based heat source to direct laser beams to a powder bed within respective FOVs such that one or more locations on the powder bed is within (i) at least two FOVs when a build plate is stationary relative to the FOVs or (ii) any of the FOVs when the build plate is moved relative to the FOVs; obtaining, by a controller, information specifying predetermined paths over which the laser-based heat source is to direct the laser beams to form objects by fusing layers of powder disposed on the powder bed; creating, by the controller, a first mapping between portions of the objects within overlapping FOVs and the laser beams associated with the overlapping FOVs; using the first mapping to determine a first distribution of the laser beams for forming the objects while balancing usage of the laser beams; configuring the laser-based heat source to direct the laser beams to locations on the powder bed in accordance with the first distribution; and emitting laser beams from the laser-based heat source. The first mapping can include, but is not limited to, a two-dimensional mapping or a three dimensional mapping with a third dimension comprising scanning positions of the objects at different scanning times.

The methods may also comprise: (responsive to a failure of one of the laser beams) identifying at least one portion of at least one of the objects that still needs to be formed and at least one of the layers of powder that needs to be fused to form the identified at least one portion; creating a second mapping between the identified layers of powder that are associated with the identified at least one portion of the at least one object and the laser beams associated with the corresponding overlapping FOVs; using the second mappings to determine a second distribution of the laser beams for forming the identified at least one portion of the at least one object while balancing usage of the laser beams; and/or configurating the laser-based heat source to direct the laser beams to locations on the powder bed in accordance with the second distribution.

The first distribution may be determined by: (i) dividing first scan times of the objects amongst the laser beams using the first mapping to obtain second scan times; (ii) adding a time value associated with an assigned object to the second scan times to obtain third scan times; (iii) identifying a laser beam with a lowest scan time of the third scan times; (iv) assigning, to the identified laser beam, scanning of an object associated with a highest scan time of ones of the first scan times that are associated with ones of the objects that are able to be scanned by the identified laser beam; and/or repeating operations (i)-(iv) until all of the objects have been assigned to the laser beams.

Alternatively, the first distribution may be determined by: (a) dividing first scan times of the objects amongst the laser beams using the first mapping to obtain second scan times; (b) computing an average scan time by averaging the first scan times; (c) computing a difference between the average scan time and each of the first scan times; (d) generating adjusted scan times by adjusting the first scan times based on a pre-specified learning rate; (e) repeating the scan time operations (c) and (d); and/or segmenting the objects in accordance with the adjusted scan times.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A powder-bed fusion system, comprising:
a laser-based heat source configured to direct laser beams to a powder bed within respective fields of views (FOVs) such that one or more locations on the powder bed is within (i) at least two FOVs when a build plate is stationary relative to the FOVs or (ii) any of the FOVs when the build plate is moved relative to the FOVs; and
a controller configured to:
obtain information specifying predetermined paths over which the laser-based heat source is to direct the laser beams to form objects by fusing layers of powder disposed on the powder bed;
create a first mapping between portions of the objects within overlapping FOVs and the laser beams associated with the overlapping FOVs;
use the first mapping to determine a first distribution of the laser beams for forming the objects while balancing usage of the laser beams; and
cause the laser-based heat source to direct the laser beams to locations on the powder bed in accordance with the first distribution.

2. The powder-bed fusion system according to claim 1, wherein the controller is further configured to:
responsive to a failure of one of the laser beams, identify at least one portion of at least one of the objects that still needs to be formed and at least one of the layers of powder that needs to be fused to form the identified at least one portion;
create a second mapping between the identified layers of powder that are associated with the identified at least one portion of the at least one object and the laser beams associated with the corresponding overlapping FOVs; and
use the second mapping to determine a second distribution of the laser beams for forming the identified at least one portion of the at least one object while balancing usage of the laser beams.

3. The powder-bed fusion system according to claim 2, wherein the controller is further configured to cause the laser-based heat source to direct the laser beams to locations on the powder bed in accordance with the second distribution.

4. The powder-bed fusion system according to claim 1, wherein the first distribution is determined by dividing first scan times of the objects amongst the laser beams using the first mapping to obtain second scan times.

5. The powder-bed fusion system according to claim 4, wherein the first distribution is determined further by performing the following operations:
adding a time value associated with an assigned object to the second scan times to obtain third scan times;
identifying a laser beam with a lowest scan time of the third scan times; and
assigning, to the identified laser beam, scanning of an object associated with a highest scan time of ones of the first scan times that are associated with ones of the objects that are able to be scanned by the identified laser beam.

6. The powder-bed fusion system according to claim 5, wherein the operations are repeated until all of the objects have been assigned to the laser beams.

7. The powder-bed fusion system according to claim 4, wherein the first distribution is determined further by performing the following scan time operations:
computing an average scan time by averaging the first scan times;
computing a difference between the average scan time and each of the first scan times; and
generating adjusted scan times by adjusting the first scan times based on a pre-specified learning rate.

8. The powder-bed fusion system according to claim 7, wherein the scan time operations are iteratively repeated.

9. The powder-bed fusion system according to claim 7, wherein the objects are segmented in accordance with the adjusted scan times.

10. The powder-bed fusion system according to claim 1, wherein the first mapping comprises a two-dimensional mapping or a three dimensional mapping with a third dimension comprising scanning positions of the objects at different scanning times.

11. A non-transitory computer-readable medium that stores instructions that is configured to, when executed by at least one computing device, cause the at least one computing device to perform operations comprising:
obtaining information specifying predetermined paths over which a laser-based heat source is to direct laser beams to form objects by fusing layers of powder disposed on a powder bed;
creating a first mapping between portions of the objects within overlapping fields of views (FOVs) and the laser beams associated with the overlapping FOVs;
using the first mapping to determine a first distribution of the laser beams for forming the objects while balancing usage of the laser beams; and
controlling the laser-based heat source to emit the laser beams and direct the laser beams to locations on the powder bed in accordance with the first distribution.

12. The non-transitory computer-readable medium according to claim 11, wherein the at least one computing device is further caused to perform operations comprising:
responsive to a failure of one of the laser beams, identifying at least one portion of at least one of the objects that still needs to be formed and at least one of the layers of powder that needs to be fused to form the identified at least one portion;
creating a second mapping between the identified layers of powder that are associated with the identified at least one portion of the at least one object and the laser beams associated with the corresponding overlapping FOVs; and
using the second mapping to determine a second distribution of the laser beams for forming the identified at least one portion of the at least one object while balancing usage of the laser beams.

13. The non-transitory computer-readable medium according to claim 12, wherein the controller is further configured to cause the laser-based heat source to direct the laser beams to locations on the powder bed in accordance with the second distribution.

14. The non-transitory computer-readable medium according to claim 11, wherein the first distribution is determined by dividing first scan times of the objects amongst the laser beams using the first mapping to obtain second scan times.

15. The non-transitory computer-readable medium according to claim 14, wherein the first distribution is determined further by performing the following scan time operations:
adding a time value associated with an assigned object to the second scan times to obtain third scan times;
identifying a laser beam with a lowest scan time of the third scan times; and
assigning, to the identified laser beam, scanning of an object associated with a highest scan time of ones of the first scan times that are associated with ones of the objects that are able to be scanned by the identified laser beam.

16. The non-transitory computer-readable medium according to claim 15, wherein the scan time operations are repeated until all of the objects have been assigned to the laser beams.

17. The non-transitory computer-readable medium according to claim 14, wherein the first distribution is determined further by performing the following scan time operations:
computing an average scan time by averaging the first scan times;
computing a difference between the average scan time and each of the first scan times; and
generating adjusted scan times by adjusting the first scan times based on a pre-specified learning rate.

18. The non-transitory computer-readable medium according to claim 17, wherein the scan time operations are iteratively repeated.

19. The non-transitory computer-readable medium according to claim 17, wherein the objects are segmented in accordance with the adjusted scan times.

20. The non-transitory computer-readable medium according to claim 11, wherein the first mapping comprises a two-dimensional mapping or a three dimensional mapping with a third dimension comprising scanning positions of the objects at different scanning times.
